(19) United States
(12) Patent Application Publication
(10) Pub. No.: US 2025/0316150 A1
(43) Pub. Date: Oct. 9, 2025

(54) COMBINATION LED LIGHTING AND DANGER DETECTION LAMP/FIXTURE APPARATUS HOST, WITH A PAIRED SUPPORTING SATELLITE, AND METHOD THEREFORE

(71) Applicant: John A. Carlin, East Amherst, NY (US)

(72) Inventor: John A. Carlin, East Amherst, NY (US)

(21) Appl. No.: 19/098,976

(22) Filed: Apr. 2, 2025

Related U.S. Application Data
(60) Provisional application No. 63/574,416, filed on Apr. 4, 2024.

(51) Int. Cl. G08B 7/06; G08B 25/10; H04W 4/90

(52) U.S. Cl. CPC G08B 7/066; G08B 25/10; H04W 4/90

(57) ABSTRACT

An improved combination lighting-danger detection apparatus and system for enhanced safety and monitoring. The system comprises a host device wirelessly connected to multiple remote sensing satellites, expanding its monitoring range and forming a distributed network. The host features both audible and visual alarms and has the capability to transmit alerts across the network, ensuring comprehensive hazard detection and response. Additionally, a base station enables users to configure preferences, manage settings, and control system operations via an integrated application, providing seamless oversight and customization.

### CROSS REFERENCE TO RELATED APPLICATION

This application claims the benefit of United States Provisional Application of John A. Carlin, application No. 63/574,416, filed 4 Apr. 2024, having the title for AN IMPROVED COMBINATION DANGER DETECTION, LED LIGHTING LAMP, AND OTHER GENERAL UTILITY HOST APPARATUS, WITH SATELLITE SUPPORTING ELEMENT, AND METHOD THEREFORE, which is incorporated herein by reference in its entirety.

### FIELD OF INVENTION

The present invention relates to the field of illuminating light bulbs that further function as a danger detection in combination with an augmenting satellite device that when combined, provides a whole-house blank of coverage, and more particularly to the detection of at least one of a smoke/fire, carbon monoxide, a gas (or other sensor means) for signaling alarms of danger and the presence thereof along with giving a safe-way-out indication.

### BACKGROUND

In the field of household safety, numerous devices are available to detect typical hazards like smoke, fire, or carbon monoxide, and provide an alarm. These devices, whether battery-operated or hard-wired, are mandated by current laws to be installed on every level of a home. Statistics demonstrate that such danger-detection devices save lives and often minimize structural damage caused by incidents like fires.

Although many more aware people install more than one danger detection device on a single level of their home, the protection coverage is still not ideal. These homeowners try to cover their property with danger detection devices by placing, for example, a smoke detector in each room. Of course, such added hazard detection does give added protection. Many manufacturers now offer their danger detection alarms with networking capabilities. Many of them are connected to a cellphone via a network Wi-Fi system. Still, with all this, it is nevertheless not ideal.

There is still a need for ‘testing’ each device for operational fitness and battery/power readiness. There is still a need for doing such testing without having to climb ladders and execute the test. And there is a need for more ‘types’ of hazard detection within the home, for example, a furnace having a leaking heat exchanger, or a leaking evaporator in a heat, ventilation, and air condition (HVAC) unit.

There are millions upon millions of homes, all with aging HVAC units and no practical way to detect the hazards of leakage of refrigerant, or exhaust gases from a leaking heat exchanger. People live 24/7 in their homes potentially poisoning them slowly. Many get up each morning with headaches, not knowing the cause is probably a small leak in the furnace heat exchanger spewing carbon monoxide (CO) into the living space of their home. This CO is not of the level, or its location, to reach the carbon monoxide detector and therefore the detector does not alarm.

Likewise, in the realm of smoke and/or carbon monoxide/gas detection devices, there exists a need to enlarge their utility. In countless applications of these devices, there is no crossover of functionality where the placement of an illuminating light bulb could also signal and alarm of a deadly element present in the immediate environment: said signaling that could produce both an audible and visual alarm and be monitored at a base station that gives a whole house overview of any situation.

Another area where detection is increasingly becoming more critical is to monitor for leaking natural gas or propane. Again, with aging homes, there are gas lines, appliances, and the like, and when a leak occurs it can become extremely dangerous. Whole houses, including some neighboring homes, can be completely leveled by explosion; as gases leak from such appliances or supply lines. The loss of life and the financial damage are catastrophic when such events happen. Yet there are no such devices for homes that can give timely hazard alerting for gas leakage, refrigerant evaporator leakages, and failed heat exchangers in furnaces.

Clearly, there is a need for improvement in the danger and hazard detection devices and systems in a home, and the alerting means to get the occupants out safely.

It is clear that there is a longstanding and significant need for a device capable of offering advanced hazard detection, notification, and evacuation guidance. Traditional safety systems often provide only basic alerts, leaving gaps in their ability to inform occupants of the exact nature of the danger or guide them to safety. This unmet need is especially critical in scenarios where time is of the essence, and clear, effective communication of hazards and safe paths is required. A comprehensive solution that addresses these shortcomings would provide an invaluable improvement to safety systems, enhancing protection and potentially saving lives.

### SUMMARY OF THE INVENTION

A general object of the present disclosure is to provide an improved combination lighting-danger detection apparatus and system, where a lighting lamp/fixture apparatus serves as a host when paired with a satellite unit(s) device that comprises a host apparatus and a satellite device and system. The host, being a lighting-danger detection lamp/fixture, and the satellite unit(s) are a remote sensing satellite type; together providing optimal sensing ability.

An object is to have an RF communication means, that gives the ability for the satellite unit(s) to communicate with the host lighting-danger detection lamp/fixture.

Another objective is the communication with the host for receiving signals from a remote sensing satellite type, whereby the signal gives added alerting ability to the host device.

Another objective said lighting-danger detection lamp/fixture, is combined with a means for sensing danger or hazards to give alarms and alerting, the receiving signals from a remote sensing satellite type, thus adding monitoring range to the host apparatus, gives greater coverage of a danger or hazard; effectively creating a distributed network of danger detection sensing.

An embodiment of the present invention for an improved lighting-danger detection lamp/fixture apparatus acting as a host, having danger and hazard sensing incorporated and will support the pairing with at least one or more remote ‘satellite’ sensor units, for detecting, alerting, and networking.

An object of the present invention for an improved lighting-danger detection lamp/fixture apparatus host is being paired with a remote satellite sensor for smoke and/or fire (heat) detection.

Another object of the present invention for an improved lighting-danger detection lamp/fixture apparatus host is being paired with a remote satellite sensor for carbon monoxide (CO) detection.

A further object of the present invention for an improved lighting-danger detection lamp/fixture apparatus host is being paired with a remote satellite sensor for gas detection. The gas is at least one of a sensor for natural gas, for propane, for radon, for refrigerant gases, or the alike.

Another objective of the present invention for an improved lighting-danger detection lamp/fixture apparatus host is being paired with a remote satellite sensor as a means to test the device for fitness, battery life, and status; said test having a remote method so as to eliminate physically handling the apparatus and thus not having to climb ladders.

One further object of the present invention for an improved lighting-danger detection lamp/fixture apparatus host being paired with a remote satellite sensor is that the 10-year-life battery-powered satellite unit can be mounted virtually anywhere and does not require commercial 120/230 VAC power in most cases. The remote satellite unit is mountable on a wall, a ceiling, or an object via having screw mount, double-sided sticky tape, or, just sitting on a shelf, an object, or the floor as the case application may require. In some applications, a commercial 120 VAC wall plug-in power transformer, having a low-voltage six-foot cord, would power the satellite unit, or recharge the battery, as may be necessary.

Still, another object of the present invention for an improved lighting-danger detection lamp/fixture host apparatus with a paired remote satellite sensor is that the satellite units are small and unobjectionable (unobtrusive), with respect to ‘blending-in’ to their surroundings.

Yet another objective of the present invention for an improved lighting-danger detection lamp/fixture host apparatus with a paired distributed network of remote satellite sensors is to provide a means for ‘whole-house’ security that covers every corner of every room, as desired; that no other danger/hazard sensors can practically provide.

Another objective of the present invention for an improved lighting-danger detection lamp/fixture host apparatus with a paired remote satellite sensor is to communicate via radio frequency (RF) communication techniques affording a separate channel between the lighting-danger detection lamp/fixture host and the remote satellite sensor unit, and, the lighting-danger detection lamp/fixture host and the remaining network system of lighting-danger detection apparatuses, and/or a compatible cellphone, and/or a base-station, and/or computer, and/or tablet therein for visual display of information, control, and status, and/or a ‘base-stations’ (may including the Amazon ALEXA, Apple HomePOD (Siri), Google-HOME, or the alike) for non-visual information, control, and status.

One other object of the present invention for an improved lighting-danger detection lamp/fixture host apparatus with a paired remote satellite sensor is all of the pairing interfaces, preset and night light level intensities and light color temperature, category, zone, and other settings are accomplished via an application (APP) on a cellphone and/or a base-station.

Another object, for a networking of devices, where no cellphone and/or base-station is available, pairing can be accomplished by an alternative self-pairing process to network; where a power-up initialization will recognize other units as being a member of the newly established network, at the time of initialization if they are all placed in close proximity to one another. The self-pairing can be upgraded to other features via the cellphone and/or base-station can be additionally processed at any time.

Another objective is to implement alternating high-intensity strobing lights (intermittent flashing) that combine colored and white light signals. The colored lights indicate the specific event, such as a danger or a safe evacuation route, while the white light enhances visibility, enabling occupants to see their surroundings. For example, red and white LEDs signify smoke or fire danger, amber and white LEDs indicate carbon monoxide (CO) presence, blue and white LEDs signal a gas hazard, and green and white LEDs mark the safe evacuation route.

In the case of an initiating danger-detecting lamp, the strobe follows a pattern of three seconds of alternating danger color and white light, each lasting for half a second, with a half-second pause of no light. This creates a pulsating visual pattern in the danger zone. For all other lamps in the network, the strobe alternates between three seconds of green and white light, each lasting for half a second, followed by half a second of the designated danger color light. This brief danger color strobe (within the green and white pulsating pattern) serves to inform occupants of the specific type of nearby danger—red for smoke or fire, amber for carbon monoxide (CO), and blue for gas. Meanwhile, the green strobe highlights the safe way out, and the white light enhances visibility to illuminate the evacuation path.

The present invention takes advantage of all these objectives by directly replacing a conventional light bulb, configured in any usual style or shape, with an improved lighting-danger detection lamp/fixture acting as a host, and with one or more of a paired remote satellite sensor, having properties to sense at least one of a smoke/fire detection, carbon monoxide detection, gas detection (gases being natural gas, propane gas, radon, or refrigerant gases); whereby pairing can be at least one or more satellite sensor units to give a reporting of a danger or hazard potential from every corner of every room to cover the home as desired; said coverage resulting in a ‘whole-house’ blanket, network protection affording early alerting with audible and meaningful colored strobe alarm lights of RED for smoke/fire, AMBER for carbon monoxide, and BLUE for gases, and importantly, GREEN strobing for visual safe-way-out indicating that a danger/hazard is nearby.

Another objective is the creation of a system that seamlessly integrates advanced lighting-danger detection with remote sensing capabilities. This system aims to provide comprehensive safety and protection for homes or buildings by combining ease of installation with sophisticated hazard detection and notification features. The goal is to establish a network of lighting-danger detection lamps or fixtures paired with affordable remote satellite sensors, monitored through optional, strategically placed base stations. These base stations would clearly display the type and location of activated alarms, ensuring timely and precise information delivery to occupants.

The overarching aim is to achieve a ‘blanket’ of protection, offering a secure and reliable means of detecting hazards, issuing alarms, and providing visual and audible guidance to facilitate safe evacuation during emergencies. This objective reflects a commitment to enhancing safety, convenience, and peace of mind for building occupants.

A further objective to be achieved is the elimination of the shortcomings associated with prior art smoke and carbon monoxide alarm devices. This includes addressing issues such as the frequent need to replace batteries, the inconvenience of silencing false alarms, and the difficulty of testing these devices. Additionally, prior art devices lack visible, colored-strobing LED lighting features for alarm indication. Even the newer 10-year battery smoke and CO detection devices, despite being networked, still fail to overcome these limitations.

The objective is to surpass conventional systems by implementing a solution that provides a more effective combination of lighting-danger detection lamps or fixtures paired with remote satellite sensor devices. Unlike prior art devices, this improved system ensures comprehensive coverage without requiring the hazard to migrate to a specific location before detection and alarm activation. This objective focuses on creating a more reliable, user-friendly, and visually enhanced safety mechanism for occupants.

Still another objective is the creation of an improved lighting-danger detection lamp or fixture paired with one or more remote satellite sensor units, offering comprehensive ‘blanket’ coverage for danger detection and hazard alerting. This disclosure uniquely addresses problems that prior art has failed to solve. Specifically, it provides a system and method capable of identifying hazards, notifying occupants, and illuminating the way to safety with greater speed and effectiveness than any other device. Unlike prior systems, this disclosure goes beyond basic alarm detection, presenting a transformative approach to safety and emergency response.

### DESCRIPTION OF THE FIGURES

FIG. 1a is an isometric illustration of a satellite unit(s) 100 of the present invention configured as a remote satellite sensor unit component, and depicts a mounting method, in accordance with an embodiment of the present disclosure; and FIG. 1b is a block diagram of the remote satellite sensor unit circuitry of the apparatus described in FIG. 1a, in accordance with an embodiment of the present disclosure;

FIG. 2 is a block diagram 10 of the improved host lighting-danger detection lamp/fixture possible layout of electronics that also shows communications to remote satellite(s) and other network devices;

FIG. 3 is a perspective view showing an illustration of the present invention of an improved lighting-danger detection lamp/fixture host 10 apparatus being paired with a plurality of satellite unit(s) 100, in accordance with an embodiment of the present disclosure;

FIG. 4a is an illustration to detail the present invention as it functions in a pairing process utilizing a cellphone application (APP) to pair a given host lighting-danger detection lamp/fixture with a remote satellite sensor unit;

FIG. 4b is an illustration of the present invention of FIG. 3 showing an implementation of several lighting-danger detection lamp/fixtures in a single room and being paired each with their own remote satellite sensor unit(s);

FIG. 5 illustrates the pairing shown in FIGS. 4a & 4b, whereby the operations are dependent on each lighting-danger detection host lamp/fixture's communications between their specific remote satellite sensor unit(s), each on their own data channel;

FIG. 6a further illustrates placement arrangements, where danger detection devices are often overlooked, the attic;

FIG. 6b is another illustration sketch arrangement, where the example placement of lighting-danger detection host lamp/fixtures examples along with their paired remote satellite sensor unit(s), is in a basement;

FIG. 7a is a depiction of an example menu of a cellphone running an application showing the PAIRING INTERFACE selections of the present invention that is referenced in FIG. 4, in accordance with an embodiment of the present disclosure;

FIG. 7b is a depiction of an example menu of a cellphone running an application showing the WHOLE HOUSE CONTROL MENU selections, in accordance with an embodiment of the present disclosure;

FIG. 8a is a depiction of an example menu of a cellphone running an application showing the SYSTEM TEST INTERFACE selections, in accordance with an embodiment of the present disclosure;

FIG. 8b is a depiction of an example menu of a cellphone running an application showing the NETWORK DETAIL MENU selections, in accordance with an embodiment of the present disclosure;

FIG. 9a is an illustration showing the inclusion of a base-station interacting with a lighting-danger detection lamp/fixture host, the lighting-danger detection host lamp further communicates with its paired remote satellite sensor unit(s), in accordance with an embodiment of the present disclosure;

FIG. 9b is an illustration of the inclusion of other smart home/internet/assistant devices and/or user-existing devices interacting with a lighting-danger detection host lamp/fixture, the lighting-danger detection host lamp further communicates with its paired remote satellite sensor unit(s), in accordance with an embodiment of the present disclosure;

FIG. 10a is a block diagram, illustrating the various routines of operation, demonstrating procedures and processes to effect the danger detection, and communications between the various (host and satellite) entities comprising the present invention; concerning cellphone pairing, data transfer, and interactions of the network, in accordance with an embodiment of the present disclosure;

FIG. 10b, is another block diagram, that illustrates further, a remote satellite configuration grouping detail, whereby there are the principal states of remote satellite function, showing ‘INPUT’ signal type, of FIG. 10a routines are processed;

FIG. 11 is another illustration, using a block diagram showing a sampling of various displays of screens, that are possible on the base-station and cellphone; the display screens reflect several situations and events of operations, in accordance with an embodiment of the present disclosure;

FIG. 12a is an illustration of a typical home's second-floor layout representing PRIOR ART and showing ‘smoke’ infiltration starting in the laundry room and migrating through the floor;

FIG. 12b is another illustration of the same typical home's second-floor layout, but representing the PRESENT INVENTION of improved lighting-danger detection lamp/fixture units with remote satellite sensing units therein in the same scenario of smoke starting in the laundry room.

### DETAIL DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Specific housing designs, menu layouts, or placements of detection devices used to illustrate the implementation for disclosure purposes, etc., relating to the embodiments disclosed herein are therefore not to be considered as limiting unless the claims expressly state otherwise.

Reference numerals that are like, refer to like indications throughout the various views of the drawings.

The present disclosure provides structure to affect a more efficient means to illuminate rooms in any home or building, alerting of danger and hazards providing smoke/fire and/or carbon monoxide and/or gas detection (gases being natural gas, propane, radon, refrigerants, etc.) to signal alarm; all in one direct replaceable package, configured to any conventional lighting-danger detection bulb/fixture of any technology.

The lighting-danger detection host device has means to pair with supporting remote satellite sensors of ‘like’ detection methods. The result of this unique approach reduces the risky guesswork of prior art (in its inability to cover whole areas effectively) and gives full control to the user as to the creation of a whole-house security, a blanket of coverage; with respect to danger alerting and a means to exit by knowing visually a safe-way-out, especially when a danger is nearby.

Having a light bulb that incorporates a smoke/fire detector, carbon monoxide detector, or gas detector (such as natural gas, propane, radon, air conditioner refrigerant, or other hazard detection means), and, with a rechargeable battery, would greatly reduce or eliminate the aforementioned problems. Such a device would be configured to replace any conventional light bulb in table lamps, recessed ceiling fixtures, or any lighting fixture.

To improve on these devices, a remote ‘satellite’ danger sensor is to be coupled by means to pair exclusively to the aforementioned lighting-danger detection lamp/fixture, light bulb as the host, thus incorporating a danger detection means both locally and remotely. These supporting element remote satellites afford added coverage by remotely placing such distinct sensing detection at places when a conventional danger detection device is not practical. The wireless communications between the host lighting-danger detection lamp/fixture and all paired remote satellites are on one channel (considered as local and is exclusive to its host), and the host lighting-danger detection lamp to a network (considered as global and shares data with peer units and a base-station if any) communications on another channel. Thus, making a practical means to monitor the whole house. The exclusive pairing of a satellite to a single host is not a limitation but is considered a benefit to limit network communication chatter.

An example of such a match-up of devices would be, a table lamp having installed one or more sensor means of a lamp-detection light bulb/fixture host (comprising at least one of a smoke/fire detector, carbon monoxide (CO) detector, a gas detector such as natural gas, propane, radon, or other hazard detection means), paired with one or more remote satellite sensors. In a scenario, a remote satellite sensor for carbon monoxide is placed at the discharge vent from the heating, ventilation, and air conditioning (HVAC). Perhaps a second CO at the return vent of the HVAC and a third at an entrance to a stairway. The single lamp-detecting light bulb/fixture is part of a network of other danger lamp-detecting lighting devices throughout the home. The remote satellite CO sensors in this scenario provide the greatest possible coverage for the chosen hazard detection giving more distant signaling of a danger. If any one of these satellites, or the main lamp-detection host lighting bulb/fixture should detect CO, the result is immediately transmitted throughout the network and the audible and visual effects begin their strobing of AMBER light of carbon monoxide, while other lighting lamp-detection devices strobe GREEN light indicating a danger nearby and a safe-way-out.

This scenario shows a single room for the ideal protection from the hazard of CO. In like manner, other remote satellite sensors, having other hazard means are also paired with like lighting lamp-detection host bulbs/fixtures that are networked. The criteria are that the lighting lamp-detector host may or may not have a like sensor to be paired with a like remote satellite sensor. In the preferred embodiment, RED and WHITE alternating strobe light is for smoke/fire. While AMBER and WHITE alternating strobe light is for carbon monoxide (CO). And, BLUE and WHITE alternating strobe light is for gases (gases being natural gas, propane, radon, refrigerant gases, methane, etc.). Other hazard detection sensor means could be other colors. But the GREEN and WHITE alternating strobe light is to indicate SAFE-WAY-OUT. That is, never exit or go to the colored strobing light, go to the green to exit. Green always means. . . . DANGER NEARBY, EXIT NOW.

Another improvement with the paired lamp-detection and remote satellite sensor devices is the process testing thereof. Currently the user of danger detection devices has to press buttons, and even climb ladders to access. Manufacturers suggest testing twice a year, or even once a month. Most people never do so because of the difficulty and the instruction is forgotten. The present invention provides a practical means to test and a means to remind when maintenance is necessary. Once a remote satellite is paired with a host lamp-detector, all test, status, and battery information is available for easy review by the user of the networked whole-home security.

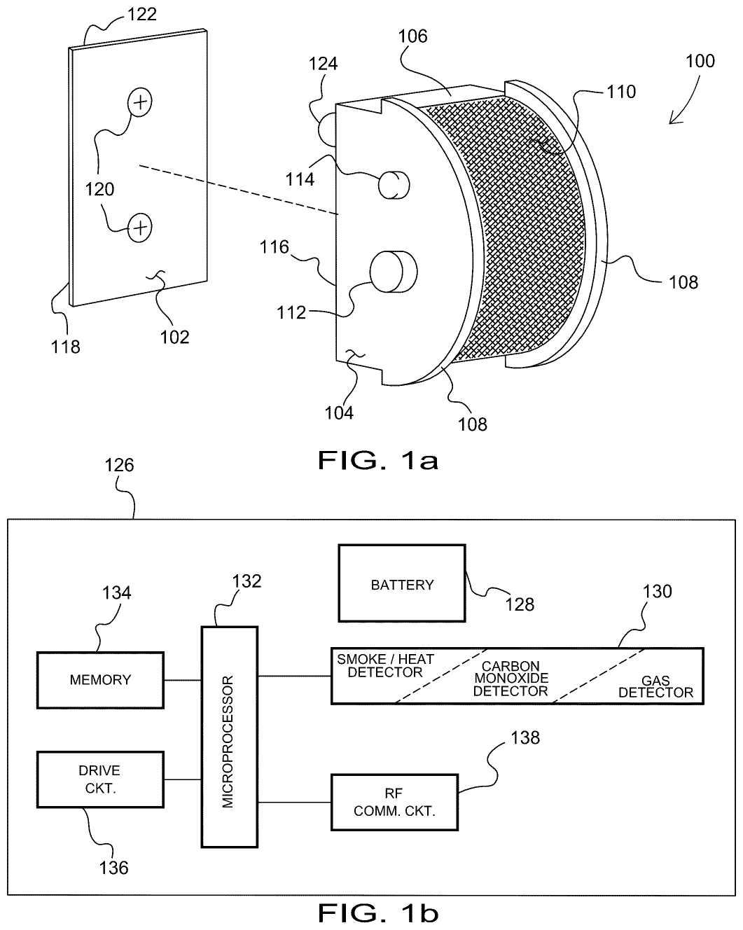

As referred to in FIG. 1a, is an isometric illustration of a remote satellite sensor 100 unit of a possible ‘field’ of satellite unit(s) 700 in an embodiment of the present invention, (one of many conceivable remote sensing satellite type 101), and depicts an optional mounting means 102. The remote satellite sensor unit comprises a housing 104, with a battery compartment 106, a wall structure 108, a vent meshing 110, a function button 112, an indicating LED 114, a snap-on clip structure 116, a backplate 118, optional mounting screws 120, an optional mounting double-sided tape 122, and a battery activation pull-tab 124.

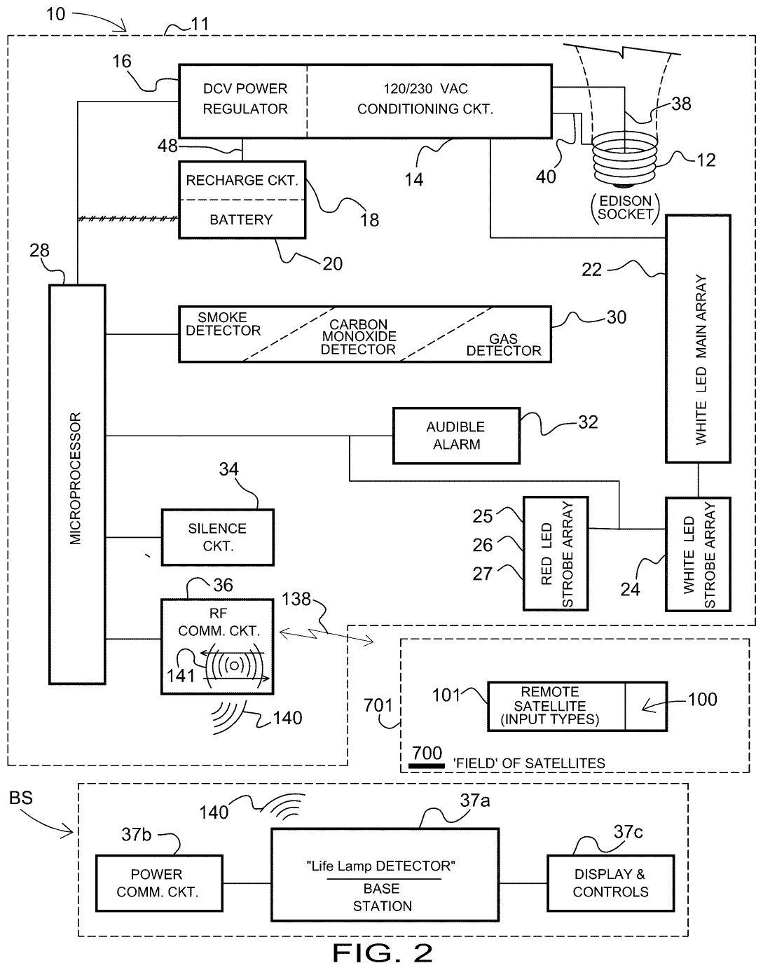

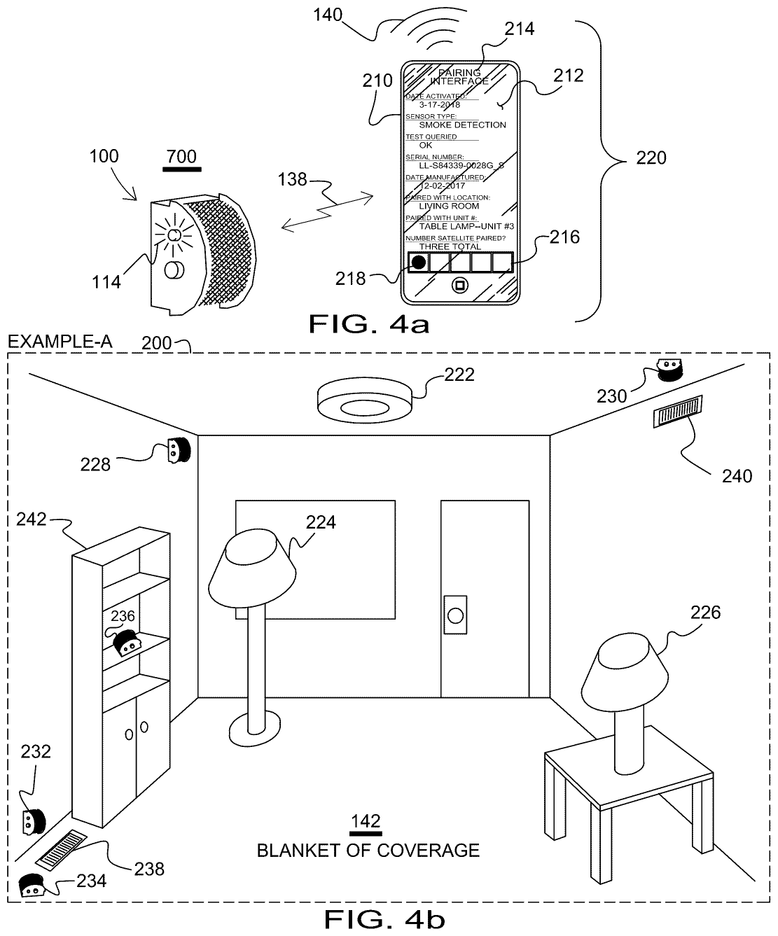

In a manner, the optional mounting means 102 would be fixed to a surface (wall, ceiling, floor, or object) by either of two means; the optional mounting screws 120 or optional mounting double-sided tape 122. Or, would simply be placed, for example, on an object, such as a shelf. The battery activation pull-tab 124 would be removed, putting the battery in contact with the circuitry powering the unit. The indicating LED 114 would flash, for example, ¼ second every 2 seconds, indicating the remote satellite sensor 100 unit is ready to be paired with a host lighting-danger detection lamp/fixture 10 (disclosed in detail in FIG. 2). The pairing process will be disclosed in FIG. 4. The remote satellite sensor 100 unit is now set to be disposed to its backplate 118 (if used), whereby there are conventional coupling clips suitable to receive the snap-on clip structure 116 (not shown) to the housing 104. These clips are simple structures within the plastic housing that allow two objects to fasten together in a secure manner and attach the two objects.

After the remote satellite sensor 100 unit is fully assembled, secured to a surface, and paired with its host (as will be discussed in FIG. 4 later), the function button 112 can be depressed to test the communication with its host. The indication LED will also flash signaling a test response. The sensing means (that will be disclosed in FIG. 2), is just beneath vent meshing 110, and allows whatever type of smoke, carbon monoxide, gases, etc., to enter. More of this operation will be fully discussed in later sections.

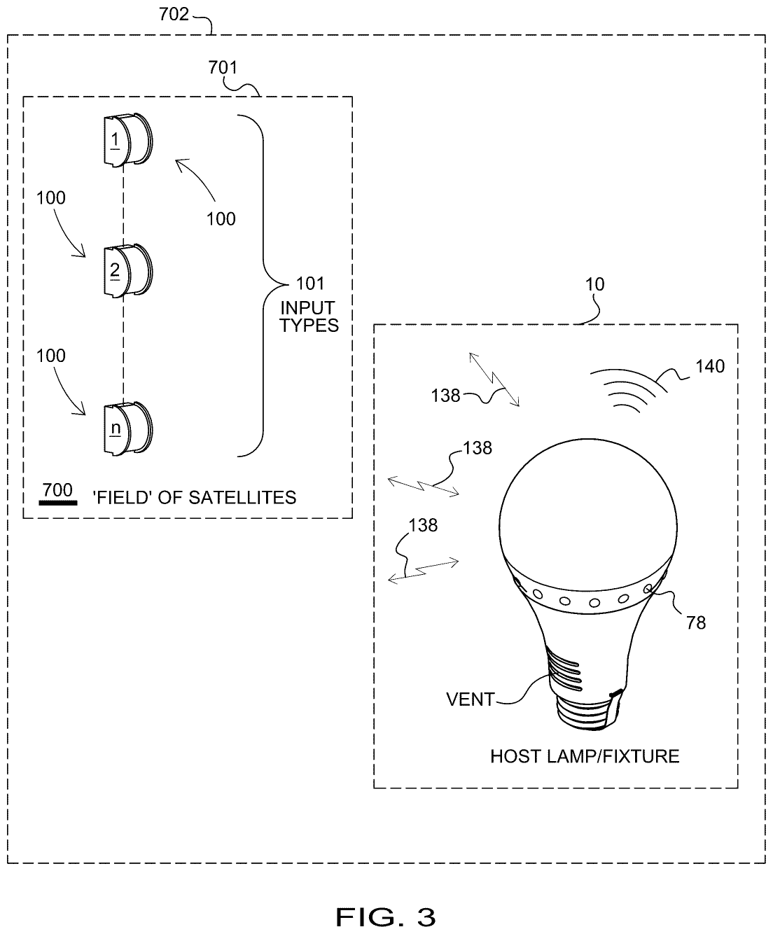

Turning now to FIG. 1b, is a block diagram of the present invention of the remote satellite sensor 100 unit circuitry of the apparatus described in FIG. 1a, and one possible layout of such circuitry is shown in electronic diagram 126. Having a battery 128, a sensor 130 (at least one of a smoke, a fire/heat, a carbon monoxide and/or a gas), a microprocessor 132, a memory 134, a drive circuitry 136, and a radio frequency circuit, local RF communication 138. The battery 128, microprocessor 132, memory 134, and any peripheral controlling circuitry referenced as drive circuitry 136 all operate as conventional microprocessor systems running routines to function for a purpose. As in the case of the preferred embodiment, the sensor 130 can be any one of a variety of sensors to perform a specific purpose; such as a smoke detector, a fire (heat) detector, a carbon monoxide detector, or a gas detector. The gas detector being any such gases as natural gas, propane gas, radon, refrigerant gas, or others. It is important to understand that the remote satellite sensor 100 unit is ‘multi-functional’, depending on what type of sensor it is constructed with, and, then it becomes part of the lighting-danger detection host lamp/fixture that serves as a remote ‘input’ (these features will be disclosed in FIG. 3, and the host lighting-danger detection lamp/fixture 10 in FIG. 2).

FIG. 2 shows a block diagram 11 depicting one possible layout of a host lighting-danger detection lamp/fixture apparatus 10, of a possible electronics layout. In this block diagram, the reference numbers show how the apparatus 10 can support the lighting-danger detection lamp/fixture as a host to remote satellites.

Shown in block diagram 11, having an electrical connection means 12 (depicted here as the familiar Edison lamp with an E26 (refers to measurement “26 mm”) style screw base, ‘A-19’ socket). A 120/230 VAC conditioning circuit 14, a DCV power regulator circuit 16, a recharge circuit 18 and a rechargeable battery 20. Further is shown, a white LED main array 22, a white LED strobe array 24 and a colored LED strobe array green 25, red 26, and amber/blue 27 as they relate to the conditioning circuit 14, and, a control microprocessor 28, as it relates to the DCV power regulator 16. The control microprocessor 28 directly controls one or more of a smoke (fire)/carbon monoxide/gas detector(s) 30, an audible alarm circuit 32, a silence circuit 34, and a communication circuit 36. The communication circuit can be present to incorporate networking features that will be disclosed in a later section. Lines 38 and 40 show 120 VAC power connections via the aforementioned conventional Edison E26 style socket providing interconnection to blocks within the diagram.

Conditioning circuit 14 supplies 120/230 VAC power to DCV regulator 16 and white LED main array 22, white LED strobe array 24, and a colored LED strobe array green 25, red 26, and amber/blue 27. The DCV power regulator provides commercial power for charging the battery 20 by the recharge circuit 18, and all of the other control components 28, 30, 32, 34, 36. In operation, when 120/230 VAC (Line Voltage) is available and present at the electrical connection means 12, the apparatus functions as follows: Conditioning circuit 14 steps-down and rectifies the VAC Line Voltage first, to the high intensity light emitting diodes (LED's) in the arrays 22 and 24, providing illuminances in the emission of visible light, and second, provide power to the DCV regulator 16 that supplies control power and the recharging of the battery as needed. Should the Line Voltage be OFF, or not present, the battery 20 will supply all necessary power to circuits 28, 30, 32, 34, 36 and the two LED strobe arrays 25, 26 & 27, and 24 when in the alarm state. It is important to understand that the white LED's in the strobe array 24 function with, and exactly the same as, white LED's in the main array 22. Only when in battery mode of operating, do the white LED's strobe the array 24, should there be an alarm. A more detailed description of all these functions will be disclosed later.

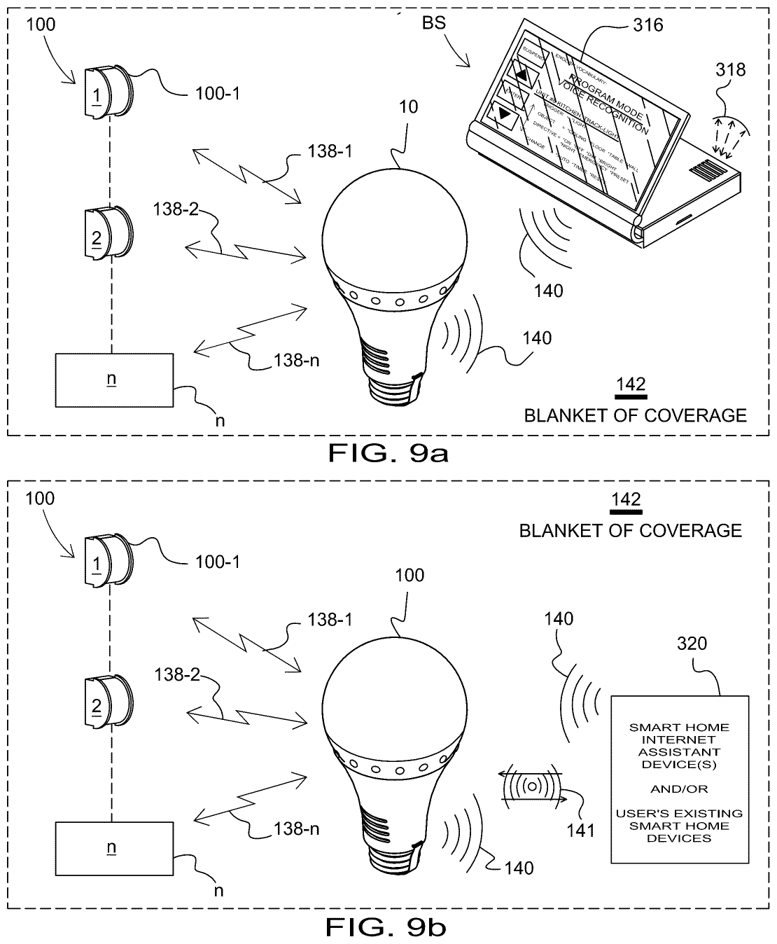

Also illustrated in FIG. 2, is a brief description of a base-station BS, for the present invention to communicate via a global RF communications 140 with the individual, improved lighting-danger detection lamp/fixture 10 host devices (that will be discussed in FIG. 9) and is illustrated in block diagram 11 above. Further, there is a local RF communication 138 that provides a reserved network between the RF communications 36 and the remote satellite sensor 100 unit(s) and will be further discussed in FIG. 3) provide signal ‘input’ to the lighting-danger detection lamp/fixture 10 host

The RF communication in the preferred embodiment of the present invention will be Bluetooth Low Energy (Bluetooth SIG, Inc., Kirkland, WA 98033, USA), but may also use Wi-Fi protocol(s). It is important to understand that specific communication protocols are indicated, but any common communication means would equally work. Other protocols are Zigbee, Z-Wave, Thread, Matter, and Ethernet to name a few. It is a goal of the present invention, to be able to communicate with other so-called ‘smart home’ devices adaptively that may not be compatible (as shown in RF communications ckt 36 as adaptive interoperability communications 141 as will be disclosed later in FIG. 9b). That is, to communicate with a user's already existing devices via the present invention; so as to not make obsolete such user's existing devices. The benefit of such adaptive ‘interoperability’ communications will become apparent later in this disclosure.

It is specifically understood that the remote satellite sensor unit(s) are acting as ‘INPUT’ signals to the improved lighting-danger detection lamp/fixture 10 host (as indicated in FIG. 1a), and, in the dashed-line box 701.

FIG. 3 is a perspective view showing an illustration of an embodiment of the present invention of a lighting-danger detection lamp/fixture host 10 apparatus being paired with a plurality (a field) of satellite unit(s) 700, of the many conceivable remote sensing satellite type 101 units, in accordance with an embodiment of the present disclosure. The lighting-danger detection lamp/fixture 10 is shown communicating with satellite unit(s) 700 via the radio frequency so-called as a local RF communication 138. Further, the lighting-danger detection lamp/fixture host 10 apparatus is additionally communicating with the so-called global RF communications 140, network of lighting-danger detection lamp/fixture host 10 apparatuses. Note that a speaker & vent holes 78, and a VENT area, allow sound, smoke, and gases to enter and exit the enclosure of the lighting-danger detection lamp/fixture host 10.

The two RF communications means aforementioned utilize the same radio frequency resources but have two protocols. The first is considered private and just between the host lighting-danger detection lamp/fixture 10 and any individual paired remote satellite sensor 100 unit. A second communication is global (and considered interacted), between the host lighting-danger detection lamp/fixture 10 and the network; comprising all of the lighting-danger detection lamp/fixture 10 in the system as well as any base-station(s) and/or other like devices (as will be discussed later).

It is important to understand, that there can be any practical number of satellite unit(s) 700 being paired to a single lighting-danger detection lamp/fixture 10 host, for example, one, five, or ten. The pairing provides a greater ‘depth’ of coverage; be it danger or hazard detection, and security. That is, such coverage affords a ‘whole-house’ blanket of well-being (from danger detection or hazards).

One further understanding should be noted, that there can be any number of host lighting-danger detection lamp/fixture 10 units in a network system (either paired with their own remote satellite sensor 100 units or just a stand-alone lighting-danger-detection lamp/fixture 10 unit). These other lighting-danger detection lamp/fixture 10 units will all communicate with one another interactively. In the case of a danger or hazard is detected, for example, smoke from a remote satellite sensor 100, such alarm would be inputted to its paired lighting-danger detection lamp/fixture 10 unit. Whereupon that individual lighting-danger detection lamp/fixture 10 would alarm with both audible alert signaling along with WHITE LED light strobing with the color RED LED light; and transmit the alert to the network; regardless of which floor (attic to basement and to include a detached garage) or if doors are open or closed. All other lighting-danger detection lamp/fixture 10 units in the system would repeat the alarm but with WHITE LED light strobing with GREEN LED light, indicating a danger is nearby, and, a safe-way-out. In this example, smoke or fire is used and the color for smoke/fire is preferred as WHITE with RED strobing LED light. If carbon monoxide (CO) was the danger, the color would be WHITE with AMBER strobing LED light, and for gas, the color would be WHITE with BLUE strobing LED light.

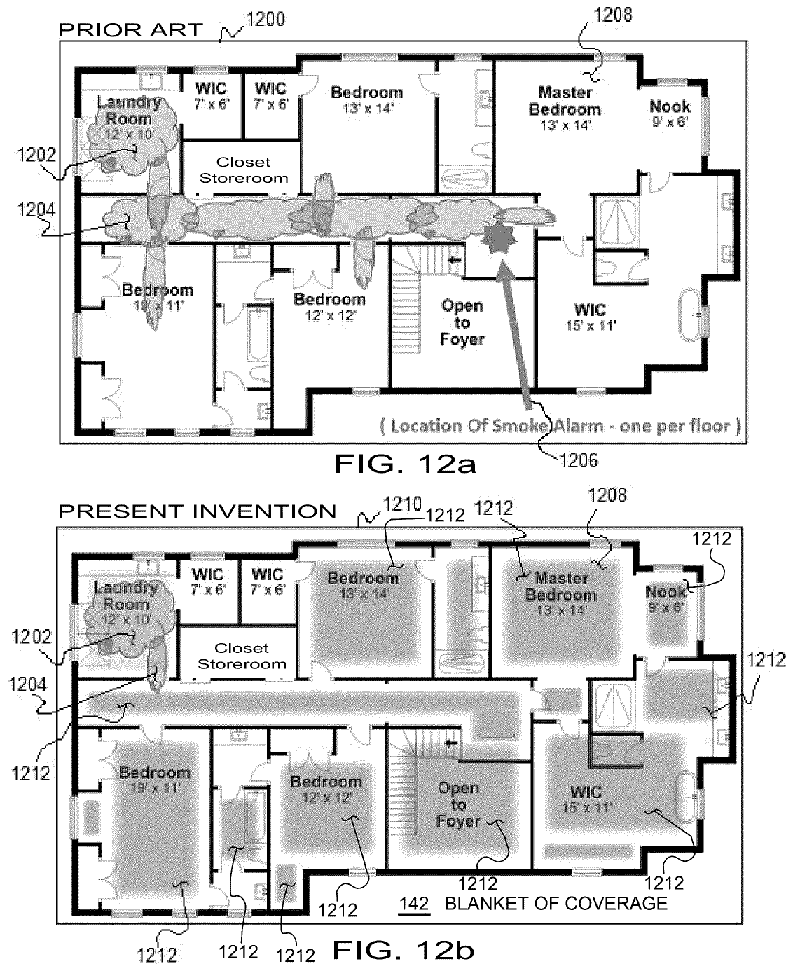

And finally, it should also be noted, that in all areas of the network, where the WHITE with GREEN strobing light is present (indicating the danger is nearby and a safe-way-out), there is a sequence to the strobing light. That is and for example, the danger detection ‘color of light’ will flash a one-half-second signal of colored light (RED, AMBER, or BLUE) depending on which alert type is detected nearby, every three seconds; to indicate to the occupant which type of danger is being alerted. The remaining three seconds in the sequence is the WHITE with GREEN strobing LED light and will remain so if and until the danger has migrated to any given lighting-danger detection lamp/fixture 10 unit strobing WHITE with GREEN, to then change to the corresponding danger color of light. More on this sequencing will be disclosed in FIG. 12.

One other option, within these configured embodiments, is the ability to make adjustments to user preferences. An example of such adjustments would be to ‘TURN-OFF or ON’, or ‘ADJUST SETTINGS’ certain detection means or sensing means; according to designed-in user preferences. One practical example would be a lighting-danger detection lamp/fixture 10 host with a smoke/fire configuration and/or a remote satellite sensor 100 smoke/fire configured unit installed in a kitchen. The user may want to disable the ‘smoke’ portion of the detection and just have the ‘fire’ portion active; to prevent false alarms due to cooking smoke or burning toast. A second example area where it is problematic for false alarming is a bathroom; where ‘steam’ may trigger an alarm and therefore a user may wish to disable that portion of the smoke/fire detector. In this manner, the fire detection (a heat detecting means) is the alerting mechanism of the remote satellite sensor 100, or its host lighting-danger detection lamp/fixture 10 units. Such turning off/on or adjusting features in either the host or satellite are easily accomplished via the cellphone APP routine process 220 or base-station BS (as will be discussed later in this disclosure) during setup or adjusted at any time to a user's preferences. Likewise, to view the status or monitor a configured component, within the system, can be queried via the same.

A dashed-line box 701 illustrates a plurality in a ‘field’ of a satellite unit(s) 700. The remote sensing satellite type 101 (providing INPUT signals) represents the many conceivable possibilities of sensors that may be utilized in the satellite (at least one of a smoke detector, a fire/heat detector, a carbon monoxide (CO) detector, a gas detector (propane, or natural, or radon), or a refrigerant detector, etc.). The illustration in the dashed-line box 701 shows that any practical number of remote satellite sensor 100 units can be paired to a single lighting danger-detection lamp/fixture 10 host unit. The ‘n’ in the box, represents a field of such sensing protection.

One final note on the expression of providing ‘INPUT’ signals, is that the input reference is with respect to their contribution to the system. That is, ‘INPUT’ refers to a signal transmitted to the host lighting-danger detection lamp/fixture 10 apparatus that an event has happened. For example, smoke detected by a remote satellite sensor 100 unit, inputs a signal to the host lighting-danger detection lamp/fixture 10 apparatus of the present invention. The improved host lighting-danger detection lamp/fixture 10 apparatus would then respond accordingly; alarming that there is a fire creating smoke. In this example, respective to the remote sensing satellite type 101 of the danger or hazard, the alert is then transmitted throughout the entire network.

FIG. 3 further illustrates the two types of communications, whereby the local RF communication 138 is exclusive to a paired individual lighting-danger detection lamp/fixture 10 host and any of the satellite unit(s) 700 apparatuses identified within dashed-line box 701. This exclusive communication is reserved only for its paired satellite units; to receive signals for the input-type remote satellites. The exclusive pairing of a satellite to a single host is not a limitation but is considered a benefit to limit network communication chatter. The global RF communications 140 is a network communication between any other lighting-danger detection lamp/fixture 10 host in the system as well as any base-station(s) that are optional to connect to the network.

The preferred communication of the present invention is Bluetooth for both the local communication 138 (as shown in FIGS. 1b, 2, 3, 4a, 5, 6a, 6b, 9a, and 9b), and the global communication 140, (as shown in FIGS. 2, 3, and 4a, 5, 6a, 6b, 7a, 9a, and 9b) but any suitable RF radio transceiver type/protocol communications can equally work. There will be more disclosure about communications and how they relate later.

Looking now at FIG. 4a, which shows an illustration to detail the remote satellite sensor 100 unit of the present invention is set up and paired. The pairing process utilizes a cellphone application (APP) that will pair any given host lighting-danger detection lamp/fixture 10 apparatus (as shown previously in FIG. 3) with a selected remote satellite. A simplified self-pairing process (not using an APP) is disclosed later.

A cellphone 210 running a menu-driven application ‘APP’ routine process 220, having an application menu 212, with a chosen pairing interface 214 routine being displayed as a taskbar selection 216, via a selection key 218. The indicator LED 114 illuminates on the remote satellite sensor 100 unit (as earlier disclosed in FIG. 1a), indicating the acceptance of a successful pairing process with a selected individual host lighting-danger detection lamp/fixture 10 apparatus. It is important to understand that once these units are paired, they only communicate with each other; no other host lighting-danger detection lamp/fixture 10 apparatus will respond to any remote satellite that is not assigned to it.

It is further important to understand that a ‘self-pairing’ process can, where there is no cellphone or base-station, alternatively establish a simple network of devices, via by just removing the battery isolation tab during initialization; when any desired units to be paired are in close proximity to one another, for example 6 to 12 inches. The operation initialization routine will recognize these units as all being members of the same network. Such simple networking can also be upgraded to a more robust network at any time using a cellphone and/or base-station as earlier mentioned.

Moving on to FIG. 4b, which illustrates an implementation arrangement, of the present invention shown in FIG. 3, whereby an installation example 200 is put into effect, using several host lighting-danger detection lamp/fixtures 10 in a single room location and being paired, each with their own remote satellite sensor 100 units (comprising a field of satellite unit(s) 700 as was discussed in FIG. 3). The installation example-A 200 shows a ceiling lamp fixture 222, a floor lamp 224, and a table lamp 226; each having a lighting-danger detection lamp/fixture 10 host. Paired with these host lighting-danger detection lamp/fixtures 10 installed in 222, 224, and 226, are a series of remote satellites; a wall-mounted unit 228 (mounted high), a ceiling-mounted unit 230, a wall-mounted unit 232 (mounted low), a floor-mounted unit 234, and a surface-placed unit 236 positioned on a shelf 242. The illustration also shows considered ‘room features’, a floor vent 238 and a wall vent 240 that are part of the HVAC ventilation system of the building structure.

All of the five ‘danger detection’ remote satellite sensor units 228, 230, 232, 234, and 236 in this example are paired with the three host lighting-danger detection lamp/fixture 10 apparatuses that are installed in 222, 224, and 226. The following are scenarios of possible arrangements (comprising a field of satellite unit(s) 700 as was discussed in FIG. 3):

### Scenario-1

a) Smoke detection from 226 with 228, 230 & 236.
b) Carbon monoxide detection from 222 with 232.
c) Refrigerant detection from 224 with 234.

### Scenario-2

d) Smoke detection from 224 with 228 & 232.
e) Carbon monoxide detection from 226 with 230 & 236
f) Gas detection from 222 with 234

### Scenario-3

g) Smoke detection from 226 with 228, 230, 232 & 236.
h) Carbon monoxide detection from 224 with 234.

In each of these example scenarios, a planned arrangement was achieved with

the present invention. In Scenario-1c, the remote satellite sensor unit 234, being a ‘refrigerant’ sensor located near, in, or around, the HVAC ventilation system discharge floor vent 238, and, paired with lighting-danger detection lamp fixture in the floor lamp 224 as the host, gave protection from a refrigerant leak being detected, in the evaporator coil in the air conditioner. That is, the refrigerant-sensing type remote satellite sensor unit 234 affixed near, in, or around surfaces or objects, such as floor or wall ventilation vents, and in this case, is disposed near the discharge floor vent 238 could easily detect refrigerant gas as it passes through and into the living space of the room whenever the ventilation system is ON. Likewise (in scenario 1a), the smoke-sensing type remote satellite sensor unit 230 (and paired with the lighting-danger detection lamp/fixture 10 in the table lamp 226) disposed near the return wall vent 240 could easily detect smoke as it is drawn to and passes through from the living space of the room and into the ventilation system.

What is demonstrated in these scenarios, the arrangement can be in many combinations illustrating the flexibility of installation. In the Scenario-3 case, the ceiling lamp fixture is not even mentioned. It could have a lighting-danger detection lamp/fixture 10 in it or just a conventional lighting bulb. The purpose of illustrating the installation ‘example-A’ 200 (showing the many possible user pairing arrangements scenarios ‘a’ through ‘h’), is to show there are many exemplary arrangements to give a ‘whole-house’ blanket of coverage 142 providing protection from danger or hazards and to show that the remote satellite sensor 100 unit can be paired with a single host lighting-danger detection lamp/fixture 10, or the lighting-danger detection lamp/fixture 10 can support multiple remote satellite sensor units of either matching types or not; all in many configurations to suit the need of the user, affording flexibility. The result is a ‘whole-house’ blanket of coverage 142 for danger or hazard detection and safe-way-out indications.

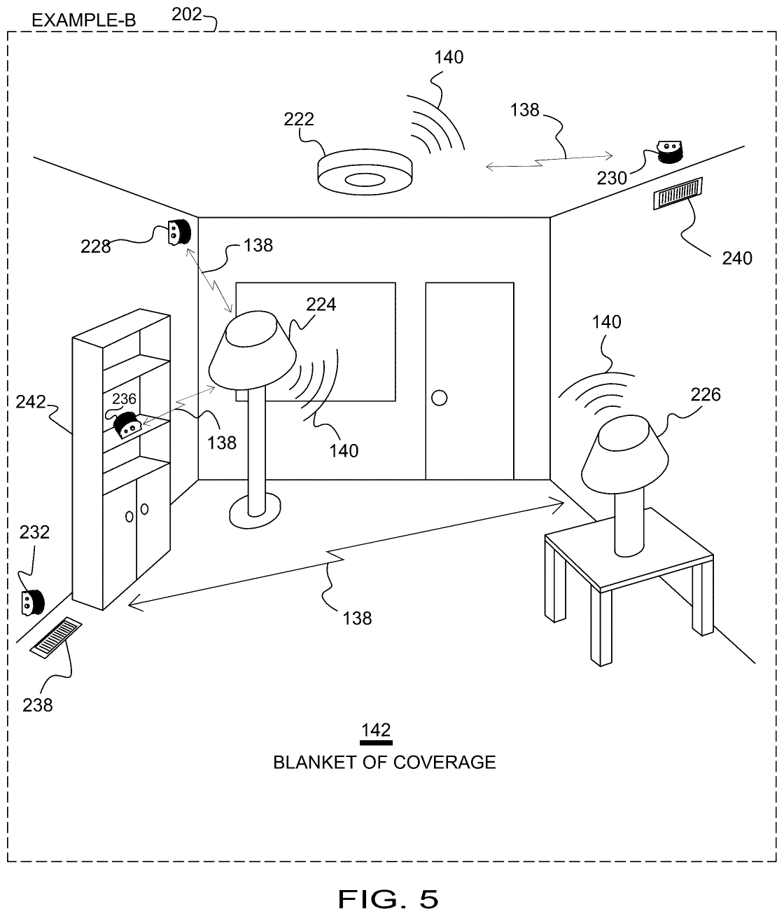

FIG. 5 illustration of the pairing, shown in FIGS. 4a & 4b, whereby the operations are independent of each lighting-danger detection host lamp/fixture 10 and communications between their specific remote satellite, each only responding to their own paring group. The installation ‘example-B’ 202, details the importance of communications within these groups. Reflected in this scenario the local communication 138 between host apparatuses installed in ceiling lamp fixture 222, floor lamp 224, and table lamp 226 to their respective remote satellite sensor units 230, 228, 236, & 232. These remote satellites only communicate with their paired host and ignore all other communications.

Whereas the global communications 140, as is depicted between all the improved lighting-danger detection lamp/fixture 10, and any other such lighting-danger detection lamp/fixture 10 in the network of the home (building, etc. to include base-stations BS or other smart home assistant devices like Alexa) that are not shown, share data. The process of these two communication ‘types’ is to limit chatter in the remote satellite sensor units. These remote satellite sensor units mostly only have battery power and therefore need to limit unnecessary data transmissions. This is accomplished by having a ‘header’ within a data transmission that is specific to a singular pairing between any given remote satellite sensor 100 unit, and its host lighting-danger detection lamp/fixture 10 at the time the pairing was created; as was disclosed in FIG. 4a, depicting the pairing interface 214.

Therefore all communications, both local communication 138 and global communications 140, in the sphere around any given remote satellite unit are totally ignored, except for such communications with a specific header owned by that specific unit and directed from its host. An example of why a host needs to communicate with a satellite would be to query a ‘test’ to check the fitness of the sensor or to get the status of the battery in the remote satellite sensor unit. And of course, should a danger be detected by a remote satellite sensor unit, its singular function is to transmit to its improved host lighting-danger detection lamp/fixture 10, the specific sensed danger/hazard. Whereby the notified host signals the alarm (audible and visual alerting that is described elsewhere in the disclosure) and then further passes the alarm to the global communication 140 network for ‘whole-house’ blanket of coverage 142, alerting and “save-way-out” indicating. And further to communicate to any base-stations and/or other systems for transfer to cellphone notification of an alerting event (which will be disclosed later).

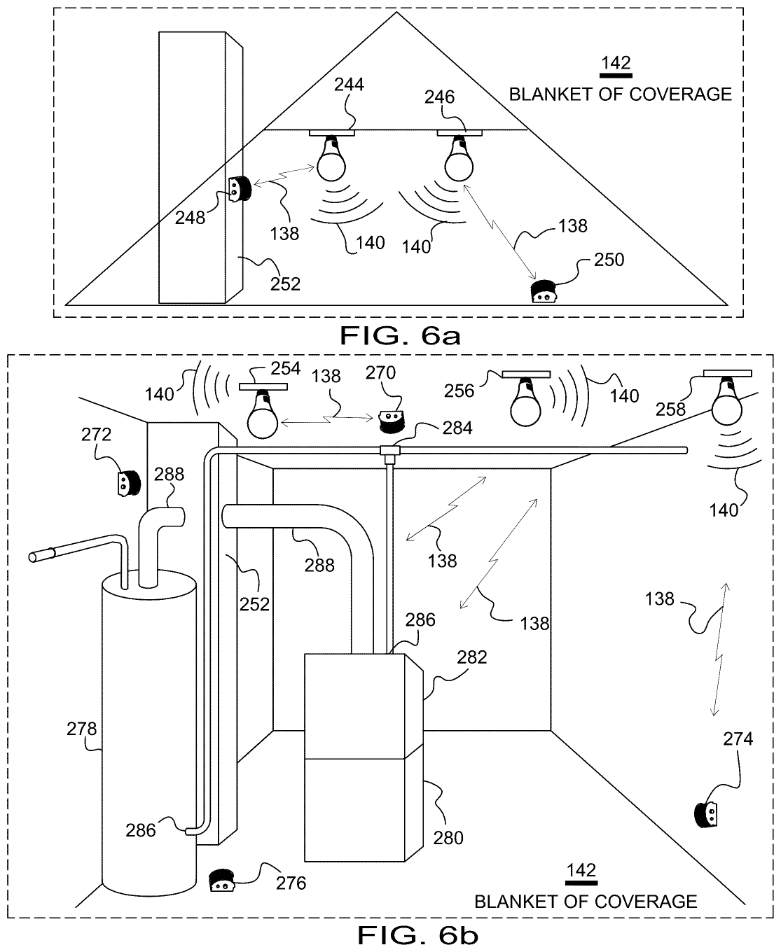

In FIG. 6a is a further illustration of placement and arrangement, where danger detection devices are often overlooked; the attic. In this scenario, ceiling fixtures 244 and 246. They are paired with remote satellite sensor 100 wall-mounted unit 248 and floor-mounted unit 250 respectively. The communications are the same as was discussed in FIG. 5 above. The danger detection example here could be the remote satellite sensor 100 unit of the wall-mounted unit 248 and disposed on the house chimney 252 is a carbon monoxide ‘type’ sensing. Chimneys could leak gases (CO) and such in an attic adds to hazards in a home; especially in older homes with the chimney mortar is loose. The other remote satellite sensor unit, floor-mounted unit 250, could be a smoke ‘type’ sensing, and complement the danger protection of the home attic.

Moving to FIG. 6b is another illustration sketch arrangement, where the example placement of an improved host lighting-danger detection lamp/fixtures 10, are examples along with their paired remote satellite sensor 100 unit, are in the basement of a home. The ceiling fixtures 254, 256, and 258, all having host lighting-danger detection lamp/fixture 10 apparatuses installed, are paired with remote satellite sensor 100 units; as ceiling-mounted unit 270, wall-mounted unit 272, wall-mounted unit 274, floor-mounted unit 276; representing the many conceivable remote satellite unit(s) 700 types as indicated in FIG. 3.

In this example arrangement, the pairing of the 254 with 270 could be of the carbon monoxide sensing ‘type’ detectors. Here these CO sensing devices cover the home HVAC furnace-section 280 unit as well as the gas-fueled water tank 278 and all of the associated appliance exhaust piping 288 to the chimney and the home chimney 252 itself.

The 256 with 272 and 276 could be of the natural gas ‘type’ sensing detectors all placed ideally; above, around, and below, where a natural gas leak could be sensed if it occurred, either from gas pipe fittings 284 or from the appliance gas connection 286; that such leaking of dangerous natural gas can be easily detected.

Further, the 258 with 274 could be ‘type’ smoke sensing detectors, covering the space both high and low. This is an ideal arrangement for hazard and danger-detecting devices, but certainly, other arrangements and pairing could be achieved. Importantly, to have a ‘whole-house’ blanket of coverage 142 protection; a basement, and an attic cannot be ignored.

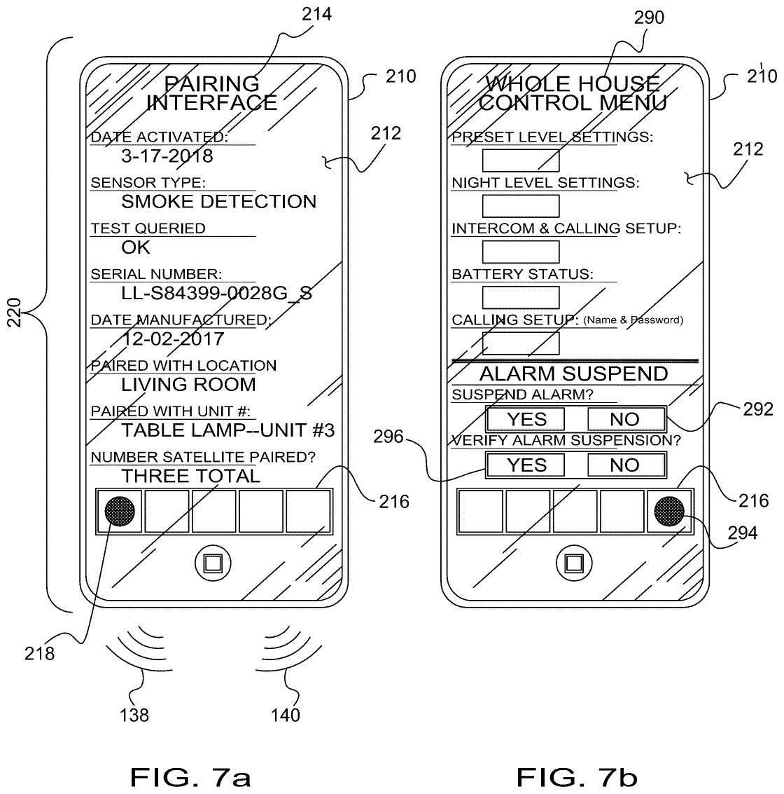

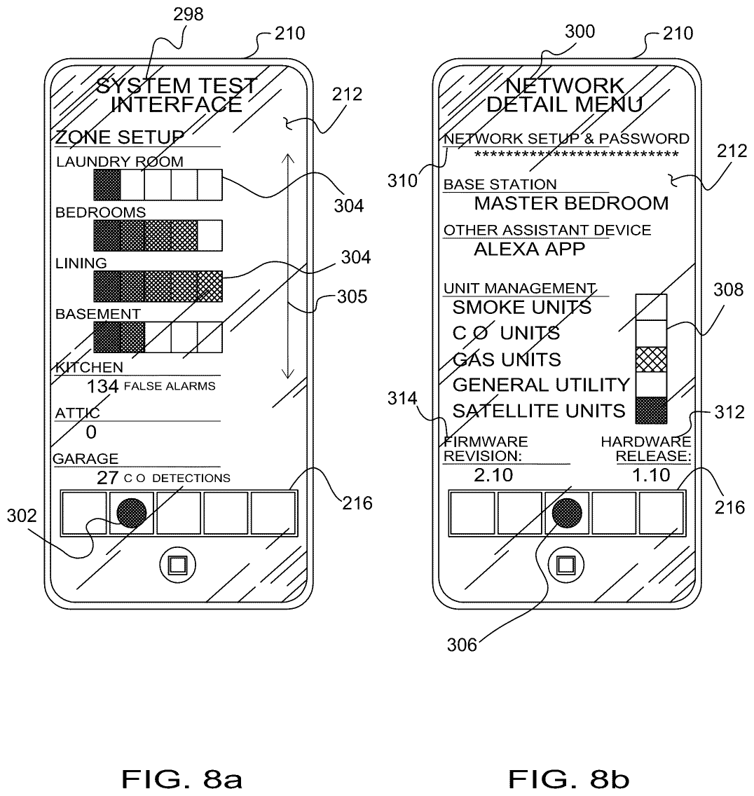

FIG. 7a is a depiction of an example menu of a cellphone running an application showing the PAIRING INTERFACE 214 selections of the present invention that is referenced in FIG. 4a; refers to reference application process 220 routines (see FIG. 4a to see the description made in the FIG. 7a disclosure). Pairing is integral to an improved lighting-danger detection lamp fixture 10 host and any satellite unit(s) 700 assigned to it, as well as any configuration and options settings that may be to any given unit depending on its particular function; to include the examples detailed in FIGS. 7b, 8a, & 8b that will follow.

The FIG. 7b depiction of an example menu for the cellphone 210, running an application menu 212 showing the WHOLE HOUSE CONTROL MENU 290 routine selections of the present invention. The taskbar 216 selects the whole house control menu 290 by pressing the selection key 294. In this routine ALARM SUSPEND control can be accessed via SUSPEND ALARM YES/NO 292 keys, and is verified via VERIFY ALARM SUSPENSION? YES/NO 296. These routines are used in the case of a false alarm such as from burning toast accidentally. The alarm will stop the audible sounding throughout the whole network during the suspension period; after which if the smoke has not ‘cleared’ the sensing detector (either the lighting-danger detection lamp fixture 10 or one of its supporting remote satellite sensor 100 units) the alarm will reinstate. The suspend time for an alarm, in the preferred embodiment is one to two minutes as a default, but this time can be user-personalized within the setup routine, any longer or shorter times.

The whole-house control menu 290 routines do other functions, for example:
PRESET SETTINGS
NIGHT LEVEL SETTINGS
LIGHT COLOR TEMPERATURE SETUP
INTERCOM SETUP
CALLING SETUP
BATTERY STATUS

These are examples of routines that the cellphone application can perform in the application's whole-house control menu 290. There is no limitation to viewing and fine-tuning any given setup of other fields of control.

Referring to FIG. 8a, it illustrates an example menu of a cellphone running an application with the SYSTEM TEST INTERFACE selections. A selection key 302 is located on the taskbar 216 of the cellphone 210, which operates the SYSTEM TEST INTERFACE 298 routine. The application menu 212 includes various zone function 304 routines, while a scroll control 305 enables other system locations to be displayed on the screen for user access. This illustration is listed:
LAUNDRY ROOM
BEDROOMS
LIVING ROOM
KITCHEN
ATTIC
GARAGE

Here whole-house parameters can be viewed and modified if desired. The application menu 212 in this case shows the ‘level’ of usage in each zone is in effect via zone functions 304. The ‘metering’ shows that the living room is using the greatest amount of lighting energy, whereas the laundry room is showing the least amount and the attic is using no energy. Also, the kitchen is showing 134 FALSE ALARMS and the garage is indicating 27 CO DETECTIONS.

All of the selections shown on the application menu 212 are examples that reflect just a few features of the system test interface 298. The screen can be ‘scrolled’ via scroll control 305 to show other features, for example, whole-house testing or zone-by-zone testing and status that allows a user to go from room-to-room performing a test of the lighting-danger detection lamp/fixtures 10 and the supporting remote satellite sensor 100 units. Importantly, this testing allows for full house testing and information status without having to physically push a button on each unit; as is the case in prior art. Further, the location selections, are more zones than are displayed and can be viewed by scrolling; for example, family room, basement, front porch, driveway, perimeter, etc.

FIG. 8b is a depiction of an example menu where the cellphone 210 is running an application showing the NETWORK DETAIL MENU 300 after a selection key 306 is pressed, of the present invention. Here the whole-house network is detailed, starting from a network setup & password 310 to a hardware release 312 version, and a firmware revision 314 are all displayed. A unit management overview 308 displays specific ‘types’ of an improved lighting-danger detection lamp/fixture 10 apparatuses and remote satellite sensor 100 units in the network, as they relate to network particulars; a means to reassign or make rank more or less prominent for example.

The application menus 212 shown in FIGS. 7a, 7b, 8a, and 8b are not confined to the specific displays or functionalities depicted. Instead, they serve as examples of what could be presented in a cellphone or computer application program. These menus represent a broader range of potential features, functions, and routines relevant to a system and network of whole-house lighting-danger detection lamp/fixture 10 apparatuses, which act as hosts to a network of supporting satellite units 700 (the remote satellite sensor 100 units), including one of many conceivable remote sensing satellite types 101. Furthermore, the cellphone 210, along with its operating application menu 212, works in coordination with the base station BS (or a tablet computer or other smart devices). The details of this interaction are elaborated in FIG. 9, which will be discussed next.

FIG. 9a is an illustration showing the inclusion of a base-station BS interacting with an improved lighting-danger detection lamp/fixture 10 host, the lighting-danger detection lamp/fixture host further communicates, via local RF communication 138, with its paired remote satellite sensor 100 unit #1 and unit #2 The remote satellite unit #n represents that there can be any number of other remote sensing satellite type 101 units, to give input to a host that can be paired, that are practically accommodated.

Still further, the improved lighting-danger detection lamp/fixture 10 host communicates to a base station BS via wireless global RF communications 140. Note with the local communication 138, there is a 138-1, a 138-2, and a 138-n signifying these are ‘private channels’ (meaning that communications is exclusive to its paired host), whereas the global communications 140 is open to all lighting-danger detection lamp/fixture 10 units and base-stations BS in the network system of devices. For communications from the base-station BS or cellphone 210, as is disclosed in FIGS. 4a, 7a & 7b, 8a, & 8b, to query a remote satellite sensor unit, such communications would need to pass through a paired host apparatus lighting-danger detection lamp/fixture 10 host first.

All the devices shown in FIG. 9a operate using the same type of RF wireless electronics; however, they function differently to conserve power for devices reliant solely on battery power, such as the remote satellite sensor 100 units (or any of the various conceivable remote sensing satellite types 101). Since RF wireless communication can consume significant power, limiting the amount of chatter in response to queries is essential. This makes exclusive pairing with a specific host crucial.

To minimize unnecessary communication (e.g., repeatedly turning communications ON and OFF), a ‘HEADER’ can mediate traffic. For instance, only a specific satellite 100-1 would respond when the ‘HEADER’ includes the RF exclusive 1-code 138-1. This exclusive code pairing would be established during the setup process between the host and satellite. Any other communications within the RF range of a satellite unit would be entirely ignored.

A second example means to limit unnecessary communications chatter, would be to use the ‘unit serial number as the’ RF communications ‘HEADER’ that gets the attention of the remote satellite unit. Or to use a second channel, such as one of a stereo setup arrangement, where the global communications is one channel and the local communications is the other. There could be other means, methods, and techniques that are as well suitable to limit communication chatter and the ones here described are exemplary and do not limit the teachings of the present invention in any way. Of course, one such other communication technique could simply be a ‘single direction’ transmission from the remote satellite to the host; thereby eliminating all unnecessary chatter altogether for the satellite unit. In such a configuration, status info (battery life, self-testing, etc.) could be regularly transmitted to the host and stored for any network inquiry that may occur.

The base-station BS has a display screen 316 which looks and functions almost like the menu screen on the cellphone application menu 212, except here there are real-time displays of whole-house monitoring status. Examples of these displays in general are:
ALL SYSTEMS OK
SMOKE-FIRE DETECTED (LAUNDRY ROOM—UNIT #12).
CO DETECTED (GARAGE—UNIT #17).
NATURAL GAS DETECTED (BASEMENT WATER TANK—UNIT #8)
REFRIGERANT LEAK DETECTED (LIVING FLOOR VENT—UNIT #3)

An audio 318 speech recognition and voice feature afford a two-way human interface between the system and the user, as events and managing are needed. These and other improved lighting-danger detection lamp fixtures 10 and any of the many conceivable field of satellite unit(s) 700 (that are disclosed in FIG. 3), e.g., remote satellite sensor 100 unit #1 (could also be any remote sensing satellite type 101 units not shown, see FIG. 3) for INPUT signals to process, can be configured to arrange a full, ‘whole-house’ blanket of coverage 142 (as referenced in FIGS. 4b 5, 6a & 6b, and 9a a& 9b) providing security, danger protection, and hazard warning functionality. The names of these units are assigned during the pairing process and are generic selections or custom-named by the user; all in a base-station BS routine.

It should be noted that the base-station (BS) described in this disclosure could function as a conventional computer tablet for monitoring, networking, and displaying system information, utilizing an application (APP) similar to the one previously disclosed for the cellphone 210. Alternatively, it could also be a conventional desktop computer running the same application. The base-station BS is preferred due to its ability to dedicate itself exclusively to monitoring the whole-house system 24/7. Ideally, one base-station would be placed in the master bedroom and another at a central location, such as the kitchen counter, for both convenience and optimal hazard alert functionality.

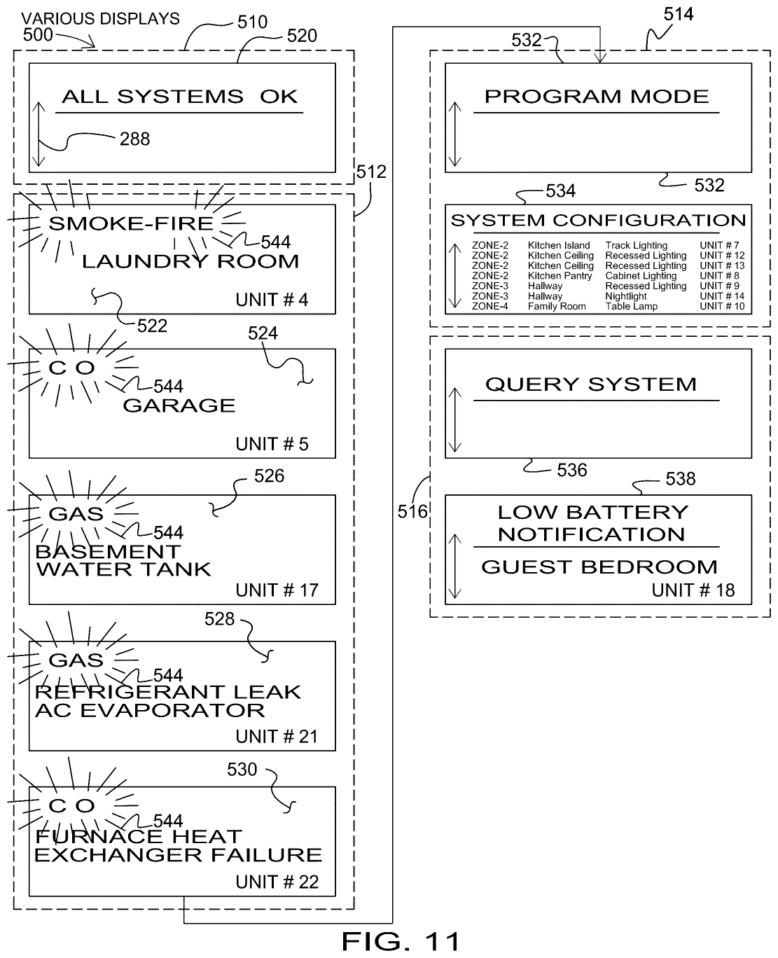

Beyond convenience, this setup provides crucial protection by alerting users to dangers and hazards while enabling prompt responses to life-threatening alarms. It also offers detailed information to identify the safest way to evacuate during emergencies. For the base-station BS located in the master bedroom, the display can be set to ‘OFF’ during night hours when NIGHT MODE is activated. This feature only disables the display while maintaining full monitoring capabilities. If an event occurs, the display automatically turns ON, presenting exact details of the alarm or situation (examples of these displays are further illustrated in FIG. 11).

Further illustrated in FIG. 9a is the versatility of the improved lighting-danger detection lamp/fixture 10 host apparatus. It can function independently, without a supporting remote satellite sensor 100 unit, or operate with a single supporting remote satellite sensor 100 unit. Additionally, it may incorporate multiple remote satellite sensor 100 units, which can all share the same sensing type, such as smoke detection. Alternatively, each remote satellite sensor 100 unit can feature a different sensing type, enabling the host to accommodate various alarm types linked to a wide range of conceivable remote sensing satellite types 101. Hazard indications are communicated through colored LEDs corresponding to the specific danger.

Importantly, there is only one sensor (or general function) in the preferred embodiment, in each remote satellite sensor unit to keep the unit physically as small as possible. This is for practical reasons and intentional; being the device is battery powered (for most units), and, the intent is to keep the purchase price as low as possible so a user could employ more satellites to achieve the ‘whole-house’ blanket of coverage 142 protection (versus the conventional danger protection of prior art of just one sensor means per floor, generally in a hallway, in a structure).

Turning to FIG. 9b, this illustration showcases the integration of various smart home devices and internet assistant systems with an improved lighting-danger detection lamp/fixture 10. The host lamp communicates both with its paired remote satellite sensor unit(s) and existing smart home devices 320, which can include popular systems currently available, such as Amazon Alexa, Google Home Assistant, Apple HomePod/Siri, Ring, Blink, Wyze, Philips Hue, Ecobee, and others.

The global RF communication 140 protocol is utilized when compatible, while an adaptive ‘interoperability’ communications 141 protocol can be selectively paired during the setup process if the devices are non-compatible. This setup routine, as described in previous sections of this disclosure, can be performed via a cellphone 210 (refer to FIGS. 4a, 7a & 7b, 8a & 8b). Additionally, certain existing smart home devices 320 may require an application (APP) upload to the lighting-danger detection lamp/fixture 10 to enable adaptive interoperability and ensure compatibility for smooth operation.

Global RF communications 140 and/or the adaptive ‘interoperability’ communications 141 would then be similar to that disclosed in FIG. 9a; to the extent that it can give meaningful interactions if the chosen device does not have a display. Nonetheless, these devices certainly can inform when danger and hazards are detected, by any of a network of improved lighting-danger detection lamp/fixture 10 host and their remote satellite sensor 100 units to give an alerting signal. Further, one goal of the adaptive ‘interoperability’ communications 141, is to not obsolete any of a user's smart home devices when adding the present invention to the mix of smart home devices in any given network of such devices.

Again, as was disclosed in FIG. 9a, the improved lighting-danger detection lamp/fixture 10 host, can optionally be selected to use other radio frequency communications, such as Wi-Fi to network; using the appropriate protocol(s). Information can be displayed via a cellphone, a tablet, a computer, a TV, or out-of-network through a base-station BS with access permission, for example. The optional selections were disclosed earlier in FIGS. 3 and 9a.

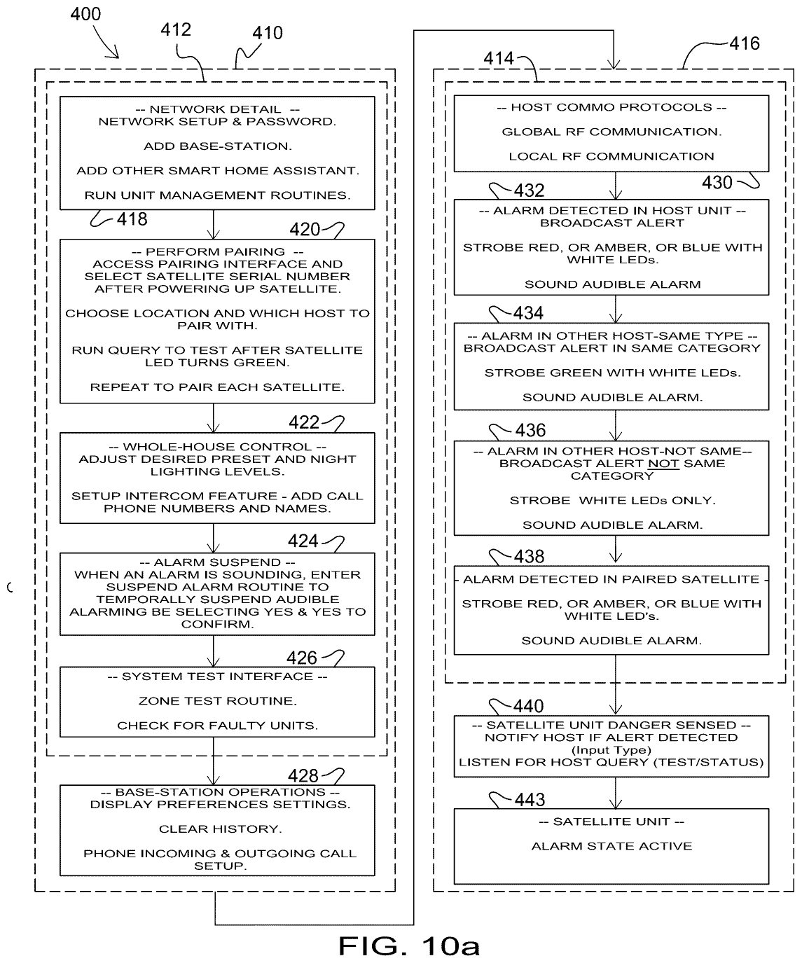

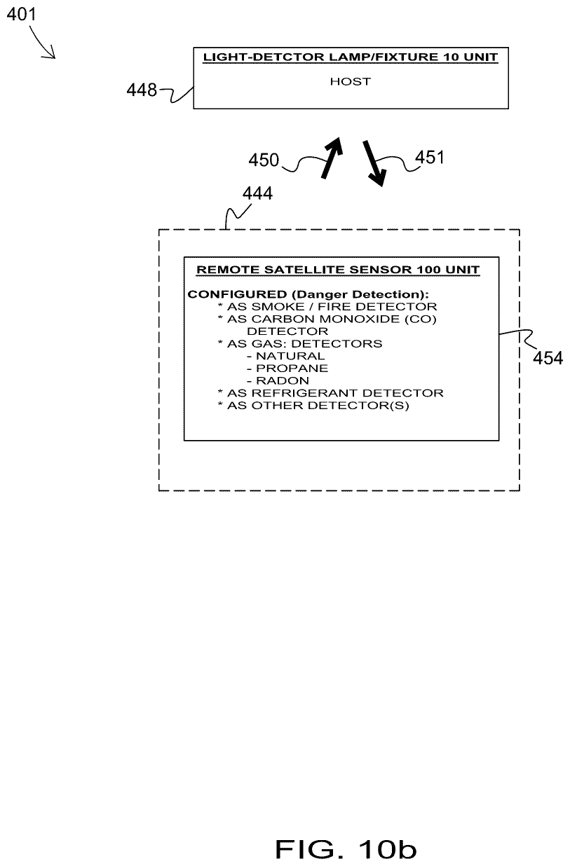

FIG. 10a provides a block diagram featuring examples of program routines 400 for operation. The diagram outlines procedures and processes essential for danger detection and communication between the entities detailed in this disclosure, including network interactions, cellphone pairing, data transfer, and hazard alerting.

The diagram includes a grouping of base-station and cellphone procedures 410, illustrating the routines responsible for establishing and managing system interactions. Additionally, there is a grouping of cellphone procedures 412. Notably, the base-station BS (depicted earlier in FIG. 9a) and the cellphone groupings (410 and 412 routines) feature similar designs and functionalities to ensure the uniformity of the whole-house system. This uniformity contributes to providing a comprehensive ‘blanket’ of protection 142, as previously detailed in earlier figures.

A network detail 418, a perform pairing 420, a whole-house control 422, an alarm suspend 424, and a system test interface 426 routines relate to the cellphone procedure grouping 412 routines, while the base-station+cellphone procedure grouping 410 includes additionally, a base-station operations 428 routines. Again, both the cellphone procedure grouping 412 and the base-station+cellphone procedure grouping 410 look and function similarly on their respective devices, to make control and operation of the whole-house system and network of devices in the present invention easy to understand and manage.

The block diagram of various routines 400 further illustrates a host apparatus grouping 414, of improved lighting-danger detection lamp/fixture 10 devices, and a host+satellite grouping 416, of the remote satellite sensor 100 units and host devices included additionally. The host apparatus grouping 414 includes a host communication protocols 430, an alarm detected in host unit 432, an alarm in other host-same type 434, an alarm in other host NOT-same type 436, and an alarm detected in paired satellite 438 routines, all relate to the host apparatus grouping 414 routines, while a host+satellite grouping 416 includes additionally a satellite unit danger sensed 440 routine and a satellite unit ALARM STATE ACTIVE 443 routines.

The routines and procedures outlined in the block diagram of program routines 400 are presented as preferred options; however, they serve merely as examples. FIG. 10b presents another block diagram, providing additional details on a remote satellite configuration grouping 401. This illustration highlights the principal states of remote satellite function, represented by a block detail 444 (pertaining to the 440 ‘INPUT’ signal type), as referenced in FIG. 10a. The input type in FIG. 10a corresponds to the satellite unit ALARM STATE ACTIVE 443, where input signals transmitted from the satellite to the host are processed.

A block 448, representing the improved lighting-danger detection lamp/fixture 10 hosts, has an arrow INPUT signal 450, from the block detail 444 (of 440 ‘INPUT’ signal type). These blocks show the configuration, listing, and grouping of the types of remote satellites as they relate to their sensing. Further, a status request 451 arrow will query the satellite of all operating parameters including test; as is indicated in system test interface routine 426 (see FIG. 10a), and the query & notification grouping 516 (see FIG. 11).

Within the block detail 444 (of 440 ‘INPUT’ signal type) grouping is a block 454 representing the remote satellite sensor 100 unit grouping. The block 454 shows the configuration (shown in Table-1) of the embodiments of the remote satellite sensor 100 unit types that relate to danger and hazard detection.

### Table-1 Configured

### (Danger Detection—Remote Satellite Sensor 100 Units):

AS SMOKE/FIRE DETECTOR
AS A CARBON MONOXIDE (CO) DETECTOR
AS GAS: DETECTOR(S)
   NATURAL
   PROPANE
   RADON
AS REFRIGERANT DETECTOR
AS OTHER DETECTOR(S)

In process, any of the configured remote satellites in the block 454 can provide a signal to input to the host in block 448 (lighting-danger detection lamp/fixture 10 unit). These INPUTS are signals that relate to the type of detector or sensor as identified in said blocks to the host, and, will be recognized with respect to the ‘type’ of alarm or hazard input as is present in the satellite unit ALARM STATE ACTIVE 443 routine (see FIG. 10a).

All these input signals are specific examples and include their various functions, program routines 400 of operation, demonstrating procedures and processes, and their remote satellite configuration groupings 401. Further, their pairing, as detailed in FIGS. 3 and 4a, shows a practical means to manage a whole house network of improved lighting-danger detection lamp/fixtures 10 host with any of the remote satellite units as listed in Tables 1.

FIG. 11 is another illustration, using a block diagram showing various displays 500, of the screens possible on the (optional) base-station BS and cellphone 210; the display screens reflect several situations and events of operations, of the present invention. A quiescent state grouping 510, is showing an ‘All Systems OK’ 520 displayed. An alarm display block 512 grouping, shows a smoke/fire alarm 522 in the laundry room displayed, a carbon monoxide (CO) alarm 524 in the garage displayed, a gas leak alarm 526 in the basement water tank of a specific natural gas type displayed, a gas leak alarm 528 in the air conditioning (AC) evaporator, specific gas type displayed, and a CO alarm 530 in the furnace heat-exchange failure, specific alarm type. All of these displays show a signaling alert 544 being flashed, in the appropriate color for the category of danger alerting, on the base-station BS (referenced in FIG. 9 earlier) display screen and/or cellphone 210 (referenced in FIGS. 7a & 7b, and 8a & 8b) display screen application menu 212.

Further illustrated in the various displays 500, is a program mode grouping 514, where a program mode 532 routine, and a system configuration 534 routine are displayed. Here the various setups and controls can be accessed; as was discussed earlier in this disclosure of the present invention.

Also, a query & notification grouping 516, shows a query system 536 and a notification displays 538, allowing inquiries into the network of devices; for pairing configurations, testing, and the status of issues and problems (if any). Also, see the process indicated on the status request 451 arrow of FIG. 10b and the system test interface routine 426 of FIG. 10a.

As with the earlier discussed section of displays, the representation of the program mode grouping 514, the query & notification grouping 516, and of the other displays illustrated in grouping shown (in base-station BS or cellphone 210) of various displays 500 (as indicated in FIG. 11) are all exemplary and those skilled in programming electronic devices can certainly devise other configurations of display screens/windows, and forms, and detail additions, to achieve the teaching of the present invention.

In FIG. 12a is an illustration (to best show the benefits of the present invention) of a typical home's second-floor layout representing PRIOR ART 1200 and showing ‘smoke’ infiltration starting in the laundry room 1202 and smoke migrating 1204 throughout the second floor of the home structure. In such a layout in this scenario, there would be a conventional smoke detector 1206 (location indicated by the arrow) for certain on each floor of the home with one in the hallway; usually at the top of the stairway location on the ceiling. The master bedroom 1208, at the other end of the hall from the laundry room, does not see, and possibly not hear an alarming conventional smoke detector 1206; especially if the room door is closed. In this scenario of prior art, precious time is lost after smoke started in the laundry room, where further, the smoke had to migrate out of the room and down the hall, to finally being detected on the ceiling at the top of the stairs by a smoke detector 1206 at the stairway location. Meanwhile, smoke is also migrating into each room along the hall in this ‘true to life’ illustration.

FIG. 12b is another illustration of the same typical home's second-floor layout. But here is shown a representation of the PRESENT INVENTION ILLUSTRATION 1210. Again, the smoke is in the laundry room 1202. And again the smoke infiltration 1204 starts in the hallway through the open door (as was indicated in FIG. 12a). But in this scenario the home is equipped with the present invention; having the improved lighting-danger detection lamp/fixture 10 and the associated field of satellite unit(s) 700 (consisting of one of the many conceivable remote sensing satellite type 101 having detection means for at least one of smoke, fire, carbon monoxide (CO), gas (propane, natural, or radon), and refrigerant, as represented as a remote satellite sensor 100 unit and comprising a ‘whole-house’ blanket of coverage 142 (as was first described in FIG. 4b), in a full representation of a distributed danger detection sensing network of devices.

Illustration 1210 demonstrates, via the rectangle and square shaded 1212 areas, where lighting lamps and fixtures are fitted with the lighting-danger detection lamp/fixture 10 devices, and commonly placed into fixtures, as would be in any conventional home, i.e., lights in every room. And are further augmented with a field of appropriate satellite unit(s) 700 as needed; bringing the detection means literally to every corner in every room as desired (individual host and satellite units are not physically shown for presentation clarity due to the small space of the illustration, only is shown their effect). The rectangle and square shaded 1212 areas represent visual alerting with colored strobing LED lights (white strobing LEDs, alternating with red would indicate smoke/fire danger is present) at the alarming location; in this case the laundry room 1202. In this scenario, all other areas (as shown via the rectangle and square shaded 1212 areas) on the second-floor of the illustration of a home structure, the alerting would be white strobing LED's alternating with green indicating an alarming state is active (somewhere in the structure) and a danger or hazard is nearby while giving indications of a safe-way-out, e.g., go toward the green light not the danger area of red light. Notably, the system and process of the improved present invention will identify, notify, and show the way out, way before any other ‘prior art’ device can. It is not just an alarm detection device as is all prior art.

The ‘visual’ alerting (along with audible) of green strobing LEDs indicating a danger nearby or a safe-way-out, as illustrated in the rectangle and square shaded 1212 areas, would also indicate a specific color of the type of danger or hazard, by flashing the specific color to a sequence, for example, one-half second of the danger color type (red for smoke/fire, amber for carbon monoxide (CO), or blue for gas) between every three seconds of the green and white strobing, thereby giving exact warning of which type of danger is nearby. Accordingly, the occupant can immediately respond to which danger is present or nearby before actually being in the mix of it. That is, the blinding effect of thick smoke, or, the ability to see (as in the case of CO but not breathe), or, the extreme need to get out due to an explosion possibility as in the case of a gas, is helpful to know, as early as possible, what one is confronted with in such dangers. The visual as well as the audible alerting and alarming is of utmost importance to save time and lives, and consequently, property, and essentially, provide ‘emergency lighting’ to see during escape from the danger; which is especially needed during nighttime hours when the home would normally be all dark.

Importantly, it must be understood that the alarming of the present invention, the system functions are irrespective of where the danger or hazard first started, or if any doors are opened or closed, or on which floor; main floor, second floor, basement, attic, or garage (as would be greatly effective over any prior art). Further, the present invention illustration 1210 amply shows that ‘time’ is of the utmost importance; giving more time to escape the danger (via following the green and white strobing lights) and exit the structure. As in comparison to the prior art 1200 illustration scenario, the smoke migration 1204 had entered fully into the hallway and all the way down to the conventional smoke detection 1206 before alerting. Note, that in the prior art 1200 illustration, that fire has also started to penetrate into the hall along with the smoke, due to the extended period of time to the smoke being detected. Here the occupants in any of the rooms would not know what kind of danger is nearby or any safe-way-out indications to exit. Indeed, the occupants would be at very high risk even to escape; being the hallway is fully engulfed with smoke and possibly fire due to the loss of time in detecting the danger.

One may ask, “Then why not just put more conventional smoke detectors in every room.” Yes, the more the better. But if they are of the conventional type of detectors and even if they are somehow ‘wired’ together and can communicate an event, there is still no immediate indication of what kind of danger or hazard is present or nearby in a panic situation, or any safe-way-out guidance. Further, even if there is a conventional detection in every room, there are no means to sense danger or hazard in every corner of every room (as the present invention, ‘field’ of satellite unit(s) 700 can provide). It is clear by these two illustrations (the prior art 1200 and the present invention illustration 1210), that the alarm, the visual and audible alerting the exact notification of the type of danger or hazard, and the guidance of a safe-way-out ability are far superior to any prior art. Especially when only a few seconds may mean life or death to the occupants, and this is especially true when it comes to gas detection; where a devastating explosion could occur. The best answer to that question earlier posed, is since lighting lamps and fixtures are everywhere in every room, why not simply fit them with devices of the improved present invention augmented with satellite units for a distributed network to broaden a danger and hazard detection ability and would result in a ‘whole-house’ blanket of coverage 142 of visual and audible alerting; that prior art cannot provide.

Lastly, the present invention illustration 1210 demonstrates that the danger or hazard is immediately known as being in the laundry room; in this scenario, it is on the second-floor back corner on the left side of the house. This information is transmitted (first by any of the satellite unit(s) if detected, to its paired host on the local RF communication 138, and, by then by the lighting-danger detection lamp/fixture 10 unit over the global RF communications 140 to any base-station and/or cellphone 210 in the network (as was earlier disclosed in FIGS. 3 & 4a). Obviously, if the host was the detecting device of the danger, it would directly transmit the alarm to the network.

The benefits of having this timely information, besides significantly aiding the occupants out of a dangerous situation to safety, is that it can also aid the fire responders in knowing exactly where the danger or hazard had originally started. Again in this scenario, the second-floor laundry room on the left-back corner of the structure would be reported (presuming the occupant had taken their cellphone with them when exiting and calling the fire department). Precious time and effort are saved to address the exact areas that need immediate attention. Safety should not be left to chance.

The importance of the examples provided in the various program routines 400 illustrated in FIGS. 10a and 10b, as well as the displays 500 shown in FIG. 11, and those displays depicted in FIGS. 7a & 7b and FIGS. 8a & 8b, lies in their representative functionality. These examples serve to demonstrate the intended features and capabilities without delving into unnecessary details. The minimum has been presented to illustrate their possibilities, ensuring clarity while avoiding limitations.

The advanced lighting-danger detection lamp/fixture 10, acting as a host and paired with a remote satellite sensor 100 apparatus (comprising a ‘field’ of satellite units 700 and accommodating any of the various remote sensing satellite types 101), exemplifies significant progress compared to prior art. This combination provides superior hazard protection, offering audible alerts through horns, sirens, or speakers (with tone or voice notifications) and visual alerts via specific color strobing lights for particular dangers. Additionally, the GREEN safe-way-out signaling technique, utilizing the green LED strobe array 25 (detailed in FIG. 2), ensures clear evacuation guidance in emergencies.

It is also important to say that the electronic layouts in FIG. 2, where the improved lighting-danger detection lamp/fixture 10 host apparatus is a ‘simplified’ version of the invention. For example, the lighting-danger detection lamp/fixture 10 apparatus has the ability to understand verbal lighting commands: ON, OFF, DIM, BRIGHT, PRESET, NIGHT, AND EMERGENCY. It can function as an intercom, record a 10-second message, playback, it can allow incoming and outgoing hands-free phone calls (via the base-station as the conduit), and can provide emergency 20% lighting during power outages for a limited time.

This advancement represents a significant improvement through the integration of the ‘field’ of satellite units 700, as exemplified by the remote sensing satellite type 101 in each configured remote satellite sensor 100 unit. These units support the host, functioning as an enhanced lighting-danger detection lamp/fixture 10 apparatus, and establish a ‘whole-house’ blanket of coverage 142 within a distributed network of devices. Remarkably, the system and device described achieve an unparalleled level of security in danger or hazard detection-offering identification, notification, and guidance to safety far more effectively and efficiently than any existing device.

IN OPERATION, an improved combination of danger detection, LED lighting lamp/fixture, serves as a host to at least one of a paired remote satellite unit apparatus as a supporting element; resulting in a ‘whole-house’ blanket of coverage when in a system of such devices. The host is a lamp housing consistent in shape and form with conventional lighting lamps/fixtures. The host LED light, combined with sensing danger or hazards and giving alarms, also can receive a sensing signal from a remote satellite supporting element with the same or other danger or hazard sensing characteristic to expand the field of detection coverage, consistent with a distributed network of devices.

The housing for the remote satellite is small and unintrusive and easily affixed to surfaces anywhere (wall high, wall low, ceiling, floor, shelf, table, etc.) within the vicinity of the lighting lamp/fixture. The housing can fixed to or be placed on any surface, or location, or object, either battery-operated or connected to commercial power via low-voltage cord and wall 120/230 VAC transformer. An alarming host, produced as the result of a sensed signal either from within the host or from a paired remote satellite, has audible and visual pulsations and can transmit such alarming to a network; alerting other such devices that a danger or hazard was detected. The network may further have optionally a cellphone and/or a base-station therein to effectively notify that a danger is nearby and immediate action must be taken.

In the pairing of devices, one can select preferences, manage settings, and control operations via an application (APP) running on a cellphone and/or base-station, to the user's ideal liking. Wherein, the select preferences, manage settings, control operations, and other adjustment features are paired as to a location, a zone, or a group of devices that are identified, preferences of light color temperature, light-level presets, and night-level presets are set, calling' names and phone numbers are added, and intercom settings selections are made.

The alarms, when communicating in the network, give warnings that are displayed on the cellphone and base-station, and for purposes of alerting other similar apparatuses, in a network, to repeat the alarm state. The host apparatus or remote satellite apparatus can be queried to ‘test’ via the network; thus, allowing not having to physically handle each unit (getting on step ladders, etc.) but giving its status electronically and displayed on the cellphone and/or base-station.

The sensing for a danger is at least one of a smoke/fire detector, carbon monoxide detector, or a gas detector. The pairing devices (host) lighting lamp/fixture and (supporting element) remote satellite element are paired exclusively with one another. The danger/hazard detection affording alarm and alerting is having visual white strobing LEDs, alternating with colored LEDs; where the color red would indicate smoke/fire, amber indicates carbon monoxide and blue indicate gas (natural, propane, radon, refrigerant, etc.), and, for green strobing LEDs for the case of a neighboring apparatus alarming a danger nearby, and further indicating a safe-way-out from the danger. The host and satellites can be queried to ‘test’ their operation status via the whole-house network.

The improved combination of danger detection utilizes an LED lighting-danger detection lamp/fixture 10 as a host. The remote satellite housing is compact and unobtrusive, making it easy to affix to various surfaces within the vicinity of the lighting-danger detection lamp/fixture 10. This housing can be mounted on any surface, location, or object, such as in, on, or around a heat ventilation and air conditioning (HVAC) vent, either at the discharge or return point.

The alarms of a host are audible (via horn, siren, speaker, whereby the speaker can notify in voice or pulsating tones, etc.) and visual (via pulsating LED strobing of colored and alternating white light), and are transmitted to a network in a home or commercial building. The network optionally has a cellphone and/or a base-station to display the current status and alarm warnings. In pairing devices, there can be preference selections, manage settings, and control operations via an application (APP) running on said cellphone and/or base-station, which allows an overview of operations and functional status. The alarms, when communicating in the network, give warnings that are displayed on the cellphone and base-station, and for purposes of alerting other similar apparatuses, in a network, to repeat the alarm state, giving notice of a danger nearby, alerting and indicating a safe-way-out. Further, the alarms can be queried to ‘test’ via network-paired cellphone or base/station.

The system, process, and apparatuses of the host lighting-danger detection lamp/fixture 10 can be paired with one or more supporting elements representing the remote satellite sensor 100 units. Each danger-type remote satellite has one of the same ‘type’ sensing detectors that is found in the host or can be of a different type of sensing depending on the configuration and purpose of the signal input desired for use by the host. The danger or hazard detection sensing devices are not limited to but are at least one of a smoke/fire detector, a carbon monoxide detector, or a gas detector. The paired devices of the improved lighting-danger detection lamp/fixture 10 host and representing the remote satellite sensor 100 units; only a host device can communicate with other host devices and to a base-station or cellphone on a global network for virtual interactions and interface to limit network chatter.

The global network base-station reference could additionally be any of the conventionally available ‘convenience-assistance devices such as Amazon's Alexa, Google-HOME, Apple, HomePod/Siri, or the alike, running an appropriate application (APP), for spoken interaction and not-visual functions to further augment the network of devices. The system, process and apparatus (in the first embodiment) is a danger/hazard detection system affording means to alarm and alerting, is having visual white strobing LEDs, alternating with colored LEDs; where the color red would indicate smoke/fire, amber indicates carbon monoxide and blue indicate a gas, and, for green strobing LEDs (green LED strobe array 25 disclosed in FIG. 2) for the case of a neighboring apparatus alarming a danger nearby, indicating a safe-way-out from the danger; whereby, gas sensing is at least one of a natural-gas detector, a propane detector, a radon detector, a refrigerant-gas(s) detector.

The combination LED improved lighting lamp/fixture embodiment, to a remote satellite unit apparatus as a supporting element is a lamp housing for the host lighting-danger detection lamps/fixtures 10 to directly replace prior art, whereby it has a conventional style Edison E-26 screw base or conventional style recessed fixture, or other type lighting fixtures with a screw base or other connections methods. Whereby the means to pair devices in said lighting-detector lamp/fixture host apparatus and said remote satellite element as a supporting apparatus to provide sensing, are paired exclusively to one another and communicate in their local network; only the host can communicate to a base-station or cellphone on a global network for visual interactions.

Whereby an LED light, combined with a means for sensing smoke/fire, carbon monoxide, gas danger, giving alarm by audible and visual alerting, the lighting responds to control commands (“ON”, “OFF”, “DIM”, “BRIGHT”, “NIGHT”, “PRESET” and “EMERGENCY”), and, also function as an intercom between lighting-danger detection lamps/fixture 10 and any networked base-stations.

With respect to pairing, a lot of discussion in this disclosure has referenced that the cellphone or base-station is used in the pairing process, but it has also been indicated as optional. Although true and will afford greater customizing of the system (such as assigning individual devices to location, zones, etc.), it is important that alternatively, pairing can be accomplished in a ‘self-pairing’ process. Such self-pairing means, for a small uncomplicated network of devices, to simply power-up the devices, in a close proximity (for example 6 to 12 inches) to one another by removing the battery isolation tab (as first disclosed in FIG. 1a). Pairing occurs during the initialization of the units when the device realizes no direction from a cellphone or base-station is present. Such self-pairing is limited in function but will fully support the colored light alerting earlier discussed and give a safe-way-out.

Given that numerous modifications, variations, and detailed changes can be applied to the described preferred embodiments, all elements in the foregoing description and accompanying drawings are to be understood as illustrative rather than restrictive. Consequently, the scope of the disclosure is to be defined by the appended claims and their legal equivalents.

An improved combination danger detection and LED lighting-danger detection lamp/fixture apparatus serves as a host, when paired with a satellite unit(s) 700 device. The system comprises a host apparatus and a satellite device, and a process. The host, is an improved lighting-danger detection lamp/fixture 10 and the satellite unit(s) 700 are a field of remote sensing satellite type 101. An RF communication 138 means, gives the ability for the satellite unit(s) 700 to communicate with the host lighting-danger detection lamp/fixture 10. The communication with the host for receiving signals from a remote sensing satellite type 101. The improved lighting-danger detection lamp/fixture 10, is combined with a means for sensing danger or hazards to give alarms and alerting. The receiving signals from a remote sensing satellite type 101, adding monitoring range to the host apparatus, gives greater coverage of a danger or hazard, thereby creating a distributed sensing network. The alarms and alerting means of the host having audible and visual pulsations, and a means to transmit such alerting to an RF communication 140 network of other lighting-danger detection lamp/fixture 10 devices (and/or facilitate adaptive ‘interoperability’ communications 141 to make non-compatible devices compatible). The network means having an optional cellphone 210 and/or a base-station BS therein. The pairing process allows the ‘field’ of satellite unit(s) 700 devices to, manage settings, and control operations and options, via an application (APP) routine process. The satellite unit(s) 700 can be queried to ‘test’ via network mean.

The satellite unit(s) 700 are designed to expand the ability of the host unit to give a more complete ‘whole-house’ blanket of coverage 142 of danger detection in a home or structure. The danger or hazard detection sensing is at least one or more of a plurality of danger sensing detector remote satellite sensor 100 units and is at least one of a smoke detector, a fire detector, a carbon monoxide detector, or a gas detector (a gas detector being one of a natural gas, a propane gas, a radon gas, or a refrigerant gas). The network means having a cellphone 210 and/or a base-station BS to pair devices, select preferences, manage settings, and control operations via an application (APP) routine process 220, wherein pairing as to a location, a zone, or a group of devices are identified, user adjustments, preferences of light level presets, night level presets are set, calling names and phone numbers are stored, and intercom selections are made. The system, and process, wherein said danger/hazard detection either from the improved host lighting-danger detection lamp/fixture 10, or the input signaling from remote satellite sensor 100 unit, affording means to alarm and alert both audibly (by a horn, or a siren, or a speaker) and visually, where the visual is white strobing LEDs, alternating with colored strobing LEDs; where a color of strobing light would indicate the type of danger or hazard, and, green strobing LEDs indicating a danger nearby and a safe-way-out from the danger. Notably, the system and process of the improved present invention will identify, notify, and show the way out of a danger.

Specifically, an improved combination lighting-danger detection apparatus and system, comprising: a host paired by a wireless communication to a series of remote sensing satellites so that the signals from the remote sensing satellites add monitoring range to the host, creating a distributed network, and wherein the host has an audible and visual alarm and the capability to transmit alerts to throughout the distributed network. Further, a base-station is used to select preferences, to manage settings, and to control operations and options via an application.

The apparatus and system, of a host is a lighting-danger detection lamp/fixture and the base-station is a computing device such as mobile device, a tablet or a personal computer, or a specifically designed dedicated device, that can be used to monitor and system test, to identify a location, a zone, or a group of devices, enables user adjustments, sets preferences for light level presets and night level presets, stores calling names and phone numbers, and makes intercom selections.

The apparatus and system of a remote sensing satellite includes at least one of the following: a smoke detector, a fire detector, a carbon monoxide detector, or a gas detector. The gas detector is one of a natural gas, a propane gas, a radon gas, or a refrigerant gas.

The apparatus and system, wherein the series of remote sensing satellites provide input signals to the lighting-danger detection lamp/fixture, to identify, notify, and show a way out of danger via a green LED strobe array either through manual commands or automatically configured settings.

An improved combination lighting-danger detection apparatus and system, comprising: a group of hosts paired by a wireless communication to a series of remote sensing satellites, wherein the hosts receive and process signals from the series of remote sensing satellites so that the signals from the remote sensing satellites adds monitoring range to the group of hosts, creating a distributed network, and wherein the hosts have a sensor for sensing danger and an audible and visual alarm and the capability to transmit alerts to throughout the distributed network and give a safe-way-out indication using a green LED strobe array; and

a base-station with a display for monitoring and system testing, used to receive warnings, select preferences, to manage settings and to control operations and adaptive interoperability communications via a routine to make non-compatible devices compatible via an application. Wherein the group of hosts are lighting-danger detection lamp/fixtures and the base-station is a computing device such as mobile device, a tablet or a personal computer that can identify a location, a zone, or a group of devices, enables user adjustments, sets preferences for light level presets and night level presets, stores calling names and phone numbers, and makes intercom selections.

The apparatus and system, wherein the series of remote sensing satellites includes at least one of the following: a smoke detector, a fire detector, a carbon monoxide detector, or a gas detector (a gas detector being one of a natural gas, a propane gas, a radon gas, or a refrigerant gas). wherein the host and at least one of the series of remote sensing satellites are paired exclusively with one another. Wherein the lighting-danger detection lamp/fixtures and at least one remote sensing satellite are exclusively paired and can be mounted or placed on any surface, location, or object, with power options including battery operation or connection to commercial power through a low-voltage cord and a 120/230 VAC wall transformer.

The apparatus and system, wherein the visual alarm is a combination of white flashing lights, alternating with colored flashing lights, to direct a safe-way-out from a danger indication; wherein the color red indicates smoke/fire, amber indicates carbon monoxide, blue indicate gas and green indicates a danger nearby and a safe-way-out from the danger.

An improved combination lighting-danger detection apparatus and system, comprising: a group of hosts paired by a wireless communication to at least one in a series of remote sensing satellites, wherein the hosts receive and process signals from the series (a field) of remote sensing satellites that adds monitoring range to a paired host within the group of hosts, creating a distributed network, and wherein the hosts have a sensor for sensing danger and an audible and visual alarm and the capability to transmit alerts to throughout the network and give a safe-way-out indication using a green LED strobe array, wherein the host's audible and visual alarm system provides auditory alerts via a horn, siren, or speaker, visual alerts through light pulsations, and transmits these alerts to the distributed network while further supporting adaptive interoperability to ensure compatibility with non-compatible devices via an uploadable routine. A base station, for monitoring and system testing, with a display is used to receive warnings, manage settings, select preferences, control operations, enable adaptive interoperability for non-compatible devices via a routine or application, and execute functions, manually or automatically, allowing users to configure installations to their desired preferences. A housing for the remote sensing satellites that contains a sensor unit, which comprises at least one of the following sensors: smoke, fire, carbon monoxide (CO), natural gas, propane, radon, or refrigerant sensor.

The apparatus and system, wherein the group of hosts are lighting-danger detection lamp/fixtures and the base-station for monitoring and system testing is a computing device such as mobile device, a tablet or a personal computer that can identify a location, a zone, or a group of devices, enables user adjustments, sets preferences for light level presets and night level presets, stores calling names and phone numbers, and makes intercom selections. Wherein the series of remote sensing satellites provide input signals to the lighting-danger detection lamp/fixture, to identify, notify, and show a way out of danger via a green LED strobe array either through manual commands or automatically configured settings. Wherein the said green strobing LEDs indicating a danger nearby or safe-way-out, emits an intermittent flashing determined by the ‘type’ of danger or hazard. Wherein a one-half second of the intermittent flashing is red for smoke/fire, amber for carbon monoxide (CO), or blue for gas between every three seconds of green and white strobing, to precisely identify the type of hazard, notify the location, and guide evacuation. Whereby the three seconds of green and white light indicating safe-way-out, are alternating high-intensity strobing light, wherein the green is the ‘safe’ indicator and the ‘white’ provides lighting to see a path for evacuation. The intermittent flashing of danger or hazard type of detection (between the three seconds of green and white safe strobing indicator) is one-half second of colored high-intensity strobing light according to the type of danger detected, giving notice of the type of danger.

The apparatus and system, wherein the pairing process of one or more remote sensing satellites is exclusive to an individual host, and where other hosts and exclusively paired remote sensing satellites, within a group of network devices, then comprises a distributed system of danger or hazard detection. Wherein a distributed system of hosts and paired remote sensing satellites of danger or hazard detecting represents a group of network devices that creates a whole-house blanket of coverage. Wherein the alarming of both audibly and visually of hosts, within a group of danger or hazard sensing detection devices, afford the earliest possible alerting whenever such alarms are given; which in turn offers the greatest amount of vital time to evacuate the danger or hazard. Wherein the base station, providing monitoring and system testing, and system configurations, indicates a system-wide notification of status, whereby all of the grouping danger or hazard detection devices within the network are in a quiescent state, display the status ‘ALL SYSTEMS OK’, or else, if any one of the plurality of hosts and/or paired remote sensing satellites give an alarm, then display the exact ‘type’ of alerting and the exact location of the alarm. Wherein the status, of either ‘ALL SYSTEMS OK’ or defining an exact ‘type’ and identifying the exact location of the alarm, is further transmitted to any other cellphones connected to the network.

An improved combination danger detection and LED lighting lamp/fixture apparatus serves as a host, when paired with a satellite unit(s) 700 device comprising a host apparatus and a satellite device, system, and process. Wherein the host, is an improved lighting-danger detection lamp/fixture 10 and a sensing type or utility type said satellite unit(s) 700 are a field and being at least one of a remote sensing satellite type 101 having danger detection type remote satellite sensor 100 unit.

A local RF communication 138 means, gives the ability for the satellite unit(s) 700 to communicate between the host lighting-danger detection lamp/fixture 10 via a pairing process. A global RF communication 140 means, gives pairing ability for host lighting-danger detection lamp/fixture 10 to a network. A lamp housing for the lighting-danger detection lamp/fixture 10 host is consistent with conventional lighting lamps/fixtures in style, form, shape, and appearance characteristics. The host is capable of receiving and processing at least one INPUT type signal from a remote sensing satellite type 101. The lighting-danger detection lamp/fixture 10, is combined with a means for sensing danger or hazards to give alarms and alerting both audibly and visually. The remote sensing satellite type 101 supporting elements comprise the same danger or hazard sensing characteristic as the host, or can support other types of sensing characteristics, which will signal its paired host of sensed processes of a danger or hazard as the case may be.

The housing for said satellite unit(s) 700 are small and unintrusive and easily affixed near, in, or around surfaces or objects anywhere within the vicinity range of the said lighting lamp/fixture host 10. The alarms and alerting means of the lighting-danger detection lamp/fixture 10 host having audible and visual pulsations, and a means to transmit such alerting to a global RF communication 140 network of other lighting-danger detection lamp/fixture 10 devices (and/or to include and facilitate adaptive ‘interoperability’ communications 141 to make non-compatible devices compatible as the case may be). The network means optionally having a cellphone 210 and/or a base-station BS therein, and the pairing process to allow the satellite unit(s) 700 devices to, select preferences, manage settings, and control operations and options, via an application (APP) routine process 220 running on said cellphone 210 and/or base-station BS.

The alerting, when communicating in the said network are giving warnings that are displayed on the cellphone 210 and optionally on base-station BS are of at least one of those in alarm display block 512 grouping, and for purposes of alerting other similar host light-detector lamp/fixture 10 apparatuses in a network, to repeat the danger or hazard alarm state and give a safe-way-out indication when appropriate via the green LED strobe array 25. The satellite unit(s) 700 can be queried to ‘test’ operational status via network means, through its paired host.

The system of the improved lighting-danger detection lamp/fixture 10 host housing can be formed to directly replace existing prior art lighting housings styles, types, forms, and shapes, and the field of satellite unit(s) 700 are designed to expand the ability of the lighting-danger detection lamp/fixture 10 host unit to give a more complete ‘whole-house’ blanket of coverage 142 of danger or hazard detection, and the utility of convenience, functionality in a home or structure. The danger or hazard detection sensing device is one or more of a plurality of danger sensing detector types of remote satellite sensor 100 units. The sensing means is at least one of a smoke detector, a fire detector, a carbon monoxide detector, or a gas detector device, whereby such detectors may be optionally adjusted to user preferences.

The pairing process of the improved lighting-danger detection lamp/fixture 10 host and the satellite unit(s) 700 are paired exclusively to one another. The network means having a cellphone 210 and/or a base-station BS to pair devices, select preferences, manage settings, and control operations via an application (APP) routine process 220, wherein pairing as to a location, a zone, or a group of devices are identified, user adjustments can be made, preferences of light level presets and light color temperature, night level presets are set, calling names and phone numbers are stored, and intercom selections are made. The danger/hazard detection either from the host lighting-danger detection lamp/fixture 10, or the input signaling from the remote satellite sensor 100 unit, affording means to alarm and alert both audibly (by a horn, or a siren, or a speaker, whereby the speaker can notify in voice or pulsating tones) and visually, where the visual is white strobing LEDs, alternating with colored strobing LEDs; where the color red would indicate smoke/fire, amber indicates carbon monoxide and blue indicate gas, and, green strobing LEDs indicating a danger nearby, and, a safe-way-out from the danger, to include for the case of a ‘neighboring’ network apparatus alarming, that a neighboring danger is nearby. Notably, the system and process of the improved present invention will identify, notify, and show the way out, way before any other device can.

Further detailed, is an improved combination danger detection and LED lighting lamp/fixture apparatus that serves as a host, when paired with a satellite unit(s) 700 device comprising, a host apparatus and a satellite device, system, and process; where the host, is an improved lighting-danger detection lamp/fixture 10 and a sensing type satellite unit(s) 700 is a ‘field’ being at least one of a remote sensing satellite type 101. Wherein, the danger detection type has a remote satellite sensor 100 unit configured as at least one of a smoke detector, a fire detector, and/or as a carbon monoxide (CO) detector, or as a gas detector, where the gas detection is natural, or propane, or radon gas.

A local RF communication 138 means, gives the ability for the satellite unit(s) 700 to communicate between the host lighting-danger detection lamp/fixture 10 via a pairing process where any practical number of satellite unit(s) can be paired to a single host. A lamp housing for the lighting-danger detection lamp/fixture 10 host is consistent with conventional lighting lamps/fixtures in style, form, shape, with some having an Edison E26 type screw base, and appearance characteristics to make upgrading to the improved system more easier and retrofittable to install. The host is capable of receiving and processing at least one INPUT type signal from a remote sensing satellite type 101. The lighting-danger detection lamp/fixture 10 host, is combined with a means for sensing danger or hazards to give alarms and alerting both audibly and visually. The remote sensing satellite type 101 supporting elements comprise the same danger or hazard sensing characteristic as the host, or can support other types of sensing characteristics, which will signal its paired host of sensed processes of a danger or hazard as the case may be to give input to the controlling light-detector lamp/fixture 10 host. A housing for the satellite unit(s) 700 are small and unintrusive and easily affixed near, in, or around surfaces or objects anywhere within the vicinity of the lighting lamp/fixture host 10 communication RF range.

The alarms and alerting means of the lighting-danger detection lamp/fixture 10 host having audible via at least one of a horn, siren, or speaker, and visual via strobing LED pulsations, and a means to transmit such alerting to a global RF communication 140 network of other lighting-danger detection lamp/fixture 10 devices, and/or to include and facilitate adaptive ‘interoperability’ communications 141 to make non-compatible devices compatible as the case may be. Wherein the network means having optionally a cellphone 210 and/or a base-station BS therein. The pairing process allows the satellite unit(s) 700 devices to select preferences, manage settings, and control operations and options, via an application (APP) routine process 220 running on the cellphone 210 and/or base-station BS to configure the system to a user's preferences. The alerting, when communicating in the network are giving warnings that are displayed on the cellphone 210 and optionally on base-station BS and having an alarm display (like those shown in) block 512 grouping, and for purposes of alerting other similar host apparatuses in a network, to repeat the danger or hazard alarm state and give a safe-way-out indication when appropriate via the green LED strobe array 25. The satellite unit(s) 700 can be queried to ‘test’ operational status via network means and view on said cellphone 210 and/or base-station BS.

The system and process of the lighting-danger detection lamp/fixture host housing can be designed to replace existing prior art lighting housings of various styles, types, forms, and shapes, enabling easier, more cost-effective upgrades that are retrofittable. Satellite units 700 enhance the functionality of the lighting-danger detection lamp/fixture host unit by expanding area coverage, providing a comprehensive whole-house blanket of hazard detection and functionality within a home or structure. Danger or hazard detection devices consist of one or more remote satellite sensors 100, which may include smoke/fire detectors, carbon monoxide detectors, gas detectors (natural, propane, or radon), or refrigerant detector devices. These sensors can be optionally adjusted based on user preferences.

The paring process of the improved lighting-danger detection lamp/fixture 10 host and the satellite unit(s) 700 are paired, either using a cellphone and/or base-station, or, a ‘self-pairing’ process to network, exclusively to one another, whereby said pairing of a host to a satellite, gives greater ‘expansion’ coverage of danger detection to a space by the addition of the satellite. The exclusive pairing of a satellite to a single host is not a limitation but is considered a benefit to limited network communication chatter. The network means having a cellphone 210 and/or a base-station BS to pair devices for setup or for viewing, select preferences, manage settings, and control operations via an application (APP) routine process 220, wherein pairing as to at least one of a location, a zone, or a group of devices are user identified, user adjustments can be made, preferences of light level presets and light color temperature, night level presets are set, calling names and phone numbers are stored, and intercom selections are made, afford greater user ease to set up and greater system functionality.

The system, and process, of the danger/hazard detection either from the host lighting-danger detection lamp/fixture 10, or the input signaling from the remote satellite sensor 100 unit, affording means to alarm and alert both audibly (by at least one of a horn, or a siren, or a speaker, whereby the speaker can notify in voice or pulsating tones) and visually, where the visual is white strobing LEDs, alternating with colored strobing LEDs; where the color red would indicate smoke/fire, amber indicates carbon monoxide and blue indicate gas, and, green strobing LEDs indicating a danger nearby and a safe-way-out from the danger, and also, for the case of a ‘neighboring’ network apparatus alarming that a neighboring danger is nearby, whereby said alarming and alerting, is near instant to the entire network of lighting-danger detection lamp/fixture 10 units and any network connected base-station BS units, as well as any cellphone 210 running an application APP routine process 220. The green strobing LEDs indicating a danger nearby or safe-way-out, would also indicate a specific color of the type of danger or hazard, by flashing the specific color to a sequence, for example, one-half second of the danger color type (red for smoke/fire, amber for carbon monoxide (CO), or blue for gas) between every three seconds of the green and white strobing, thereby giving exact warning of which type of danger is nearby. Resulting in a ‘whole-house’ blanket of coverage 142. Notably, the system and process of the improved present invention will identify (an exact danger or hazard by the type of sensed detection), notify (and exact location of the alerting, and show the way out (from the presence of danger or hazard via visual colored green strobing of light), way before any other device can. The host and satellite danger and/or hazard sensing/detection and alarming/alerting is not just an alarm detection device as is all prior art. It greatly improves and advances safety by the earliest possible notification so occupants can escape such life-threatening dangers.

It is to be understood that the drawings and descriptive matter are in all cases to be interpreted as merely illustrative of the principles of the disclosure, rather than as limiting the same in any way, since it is contemplated that various changes may be made in various elements to achieve like results without departing from the spirit of the disclosure or the scope of the appended claims. All documents cited in the Detailed

Description of the disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

### REFERENCES (PRESENT INVENTION)

10 LIGHTING-DANGER DETECTION LAMP/FIXTURE (apparatus)

11 BLOCK DIAGRAM (of host electronics 10)

12 ELECTRICAL CONNECTION MEANS

14 CONDITIONING CIRCUIT

16 DCV POWER REGULATOR CIRCUIT

18 RECHARGE CIRCUIT

20 RECHARGEABLE BATTERY

22 WHITE LED MAIN ARRAY

24 WHITE LED STROBE ARRAY

25 GREEN LED STROBE ARRAY (safe-way-out indication)

26 RED LED STROBE ARRAY

27 AMBER OR BLUE LED STROBE ARRAY

28 CONTROL MICROPROCESSOR

30 SMOKE/CARBON MONOXIDE/GAS DETECTOR(S)

32 AUDIBLE/VISUAL ALARM CIRCUIT

34 SILENCE CIRCUIT

36 RF COMMUNICATIONS CKT.

BS BASE-STATION

37a BASE-STATION (electronics)

37b BASE-STATION (power ckt)

37c BASE-STATION (display & controls)

38 LINE (interconnecting)

40 LINE (interconnecting)

78 SPEAKER & VENT HOLES (sound, smoke, and gases to enter and exit)

VENT (area)

100 REMOTE SATELLITE SENSOR UNIT

101 REMOTE SENSING SATELLITE TYPE-(input sensing types)

102 MOUNTING MEANS

104 HOUSING

106 BATTERY COMPARTMENT

108 WALL STRUCTURE

110 VENT MESHING

112 FUNCTION BUTTON

114 INDICTING LED

116 SNAP-ON CLIP STRUCTURE

118 BACKPLATE

120 OPTIONAL MOUNTING SCREWS

122 OPTIONAL MOUNTING DOUBLE-SIDED TAPE

124 BATTERY ACTIVATION PULL-TAB

126 ELECTRONIC DIAGRAM

128 BATTERY

130 SENSOR (could be any one of several types)

132 MICROPROCESSOR

134 MEMORY

136 DRIVE CIRCUITRY

138 LOCAL RF COMMUNICATION

140 GLOBAL RF COMMUNICATIONS

141 ADAPTIVE ‘INTEROPERABILITY’ COMMUNICATIONS

142 BLANKET OF COVERAGE (whole-house danger detection)

200 INSTALLATION EXAMPLE-A

202 INSTALLATION EXAMPLE-B

210 CELLPHONE (with application APP routine)

212 APPLICATION MENU

214 PAIRING INTERFACE (routine)

216 TASKBAR SELECTION

218 SELECTION KEY

220 APP ROUTINE PROCESS

222 CEILING LAMP FIXTURE

224 FLOOR LAMP

226 TABLE LAMP

228 WALL-MOUNTED UNIT (mounted high)

230 CEILING-MOUNTED UNIT

232 WALL-MOUNTED UNIT (mounted low)

234 FLOOR-MOUNTED UNIT

236 SURFACE-PLACED UNIT

238 FLOOR VENT

240 WALL VENT

242 SHELF

244 CEILING FIXTURE

246 CEILING FIXTURE

248 WALL-MOUNTED UNIT

250 FLOOR-MOUNTED UNIT

252 HOUSE CHIMNEY

254 CEILING FIXTURE

256 CEILING FIXTURE

258 CEILING FIXTURE

270 CEILING-MOUNTED UNIT

272 WALL-MOUNTED UNIT (mounted high)

274 WALL-MOUNTED UNIT (mounted low)

276 FLOOR-MOUNTED UNIT

278 WATER TANK

280 HOME HVAC FURNACE-SECTION

282 HOME HVAC EVAPORATOR-SECTION (air conditioning)

284 GAS PIPE FITTINGS

286 APPLIANCE GAS CONNECTION

288 APPLIANCE EXHAUST PIPING

290 WHOLE HOUSE CONTROL MENU (routine)

292 SUSPEND ALARM YES/NO

294 SELECTION KEY

296 VERIFY ALARM SUSPENSION? YES/NO

298 SYSTEM TEST INTERFACE (routine)

300 NETWORK DETAIL MENU (routine)

302 SELECTION KEY

304 ZONE FUNCTIONS (metering)

305 SCROLL CONTROL

306 SELECTION KEY

308 UNIT MANAGEMENT OVERVIEW

310 NETWORK SETUP & PASSWORD

312 HARDWARE RELEASE

314 FIRMWARE REVISION

BS BASE-STATION

N SPECIFIC n-SATELLITE

138-1 RF EXCLUSIVE 1-CODE

138-2 EXCLUSIVE 2-CODE

138-n RD EXCLUSIVE n-CODE

316 DISPLAY SCREEN

318 AUDIO (speech recognition & voice)

320 EXISTING ‘SMART HOME’ DEVICES (Amazon ALEXA, Google—HOME, Apple HomePOD, or other user devices)

400 VARIOUS PROGRAM ROUTINES

401 REMOTE SATELLITE CONFIGURATION GROUPINGS

410 BASE-STATION+CELLPHONE PROCEDURE GROUPING

412 CELLPHONE PROCEDURE GROUPING

414 HOST APPARATUS GROUPING (lighting-danger detection lamp/fixture 10 device)

416 HOST+SATELLITE GROUPING (remote satellite sensor 100 unit & host)

418 NETWORK DETAIL ROUTINES

420 PERFORM PAIRING ROUTINE

422 WHOLE-HOUSE CONTROL ROUTINES

424 ALARM SUSPEND ROUTINES

426 SYSTEM TEST INTERFACE ROUTINES

428 BASE-STATION OPERATIONS ROUTINES

430 HOST COMMUNICATION PROTOCOLS ROUTINES

432 ALARM DETECTED IN HOST UNIT ROUTINES

434 ALARM IN OTHER HOST-SAME TYPE ROUTINES

436 ALARM IN OTHER HOST-NOT SAME ROUTINES

438 ALARM DETECTED IN PAIRED SATELLITE ROUTINES

440 SATELLITE UNIT DANGER SENSED ROUTINES

443 SATELLITE UNIT-ALARM STATE ACTIVE

444 BLOCK DETAIL (of 440 ‘input’ signal)

448 BLOCK (lighting-danger detection lamp/fixture 10 host)

450 ARROW (INPUT signals)

451 STATUS REQUEST (from host to satellite)

500 VARIOUS DISPLAYS (base-station and/or cellphone)

510 QUIESCENT STATE GROUPING (All Systems OK)

512 ALARM DISPLAY BLOCK (danger/hazard alerting grouping)

514 PROGRAM MODE GROUPING (system configurations)

516 QUERY & NOTIFICATION GROUPING

518 GENERAL UTILITY GROUPING

520 ALL SYSTEMS OK

522 SMOKE/FIRE ALARM

524 CARBON MONOXIDE (CO) ALARM

526 GAS LEAK ALARM (water tank natural gas specific)

528 GAS LEAK ALARM (AC evaporator refrigerant gas specific)

530 CARBON MONOXIDE (CO) ALARM (furnace heat-exchanger specific)

532 PROGRAM MODE DISPLAY

534 SYSTEM CONFIGURATION ROUTINES

536 QUERY ROUTINES

538 NOTIFICATION DISPLAYS

544 SIGNALING ALERT (in appropriate category color RED, AMBER or BLUE strobing sight)

700 SATELLITE UNIT(S)

701 DASHED-LINE BOX

1200 PRIOR ART (conventional smoke detection devices)

1202 LAUNDRY ROOM

1204 SMOKE MIGRATION

1206 CONVENTIONAL SMOKE DETECTION (at stairway location)

1208 MASTER BEDROOM

1210 PRESENT INVENTION ILLUSTRATION

1212 RECTANGLE AND SQUARE SHADED (areas indication green strobing light)

What is claimed is:

1. An improved combination lighting-danger detection apparatus and system, comprising:
a host paired by a wireless communication to a series of remote sensing satellites so that the signals from the remote sensing satellites adds monitoring range to the host, creating a distributed network, and wherein the host has an audible and visual alarm and the capability to transmit alerts to throughout the distributed network; and
a base-station used to select preferences, to manage settings and to control operations and options via an application.

2. The apparatus and system of claim 1, wherein the host is a lighting-danger detection lamp/fixture and the base-station is a computing device such as mobile device, a tablet or a personal computer that can identify a location, a zone, or a group of devices, enables user adjustments, sets preferences for light level presets and night level presets, stores calling names and phone numbers, and makes intercom selections.

3. The apparatus and system of claim 1, wherein the series of remote sensing satellites includes at least one of the following: a smoke detector, a fire detector, a carbon monoxide detector, or a gas detector.

4. The apparatus and system of claim 2, wherein the series of remote sensing satellites provide input signals to the lighting-danger detection lamp/fixture, to identify, notify, and show a way out of danger via a green LED strobe array either through manual commands or automatically configured settings.

5. An improved combination lighting-danger detection apparatus and system, comprising:
a group of hosts paired by a wireless communication to a series of remote sensing satellites, wherein the hosts receive and process signals from the series of remote sensing satellites so that the signals from the remote sensing satellites adds monitoring range to the group of hosts, creating a distributed network, and wherein the hosts have a sensor for sensing danger and an audible and visual alarm and the capability to transmit alerts to throughout the distributed network and give a safe-way-out indication using a green LED strobe array; and
a base-station with a display for monitoring and system testing, used to receive warnings, select preferences, to manage settings and to control operations and adaptive interoperability communications via a routine to make non-compatible devices compatible via an application.

6. The apparatus and system of claim 5 wherein the group of hosts are lighting-danger detection lamp/fixtures and the base-station is a computing device such as mobile device, a tablet or a personal computer, or a specifically designed dedicated device that can identify a location, a zone, or a group of devices, enables user adjustments, sets preferences for light level presets and night level presets, stores calling names and phone numbers, and makes intercom selections.

7. The apparatus and system of claim 6, wherein the series of remote sensing satellites includes at least one of the following: a smoke detector, a fire detector, a carbon monoxide detector, or a gas detector.

8. The apparatus and system of claim 5, wherein the host and at least one of the series of remote sensing satellites are paired exclusively with one another.

9. The apparatus and system of claim 6, wherein the lighting-danger detection lamp/fixtures and at least one remote sensing satellite are exclusively paired and can be mounted or placed on any surface, location, or object, with power options including battery operation or connection to commercial power through a low-voltage cord and a 120/230 VAC wall transformer.

10. The apparatus and system of claim 6, wherein the visual alarm is a combination of white flashing lights, alternating with colored flashing lights, the group of hosts will strobe a specific danger color light interspersed with white light strobing, to direct a safe-way-out from a danger; wherein the color red indicates smoke/fire, amber indicates carbon monoxide, blue indicate gas and green indicates a danger nearby and a safe-way-out from the danger.

11. An improved combination lighting-danger detection apparatus and system, comprising:
a group of hosts paired by a wireless communication to at least two in a series of remote sensing satellites, wherein the hosts receive and process signals from the series of remote sensing satellites that adds monitoring range to a paired host within the group of hosts, creating a distributed network, and wherein the hosts have a sensor for sensing danger and an audible and visual alarm and the capability to transmit alerts to throughout the network and give a safe-way-out indication using a green LED strobe array, wherein the host's audible and visual alarm system provides auditory alerts via a horn, siren, or speaker, visual alerts through light pulsations, and transmits these alerts to the distributed network while further supporting adaptive interoperability to ensure compatibility with non-compatible devices via an uploadable routine;
a base station, for monitoring and system testing, with a display is used to receive warnings, manage settings, select preferences, control operations, enable adaptive interoperability for non-compatible devices via a routine or application, and execute functions, manually or automatically, allowing users to configure installations to their desired preferences; and
a housing for the remote sensing satellites that contains a sensor unit, which comprises at least one of the following sensors: smoke, fire, carbon monoxide (CO), natural gas, propane, radon, or refrigerant sensor.

12. The apparatus and system of claim 10 wherein the group of hosts are lighting-danger detection lamp/fixtures and the base-station for monitoring and system testing is a computing device such as mobile device, a tablet or a personal computer that can identify a location, a zone, or a group of devices, enables user adjustments, sets preferences for light level presets and night level presets, stores calling names and phone numbers, and makes intercom selections.

13. The apparatus and system of claim 11, wherein the series of remote sensing satellites provide input signals to the lighting-danger detection lamp/fixture, to identify, notify, and show a way out of danger via a green LED strobe array either through manual commands or automatically configured settings.

14. The apparatus and system of claim 12, wherein the said green strobing LEDs indicating a danger nearby or safe-way-out, emits an intermittent flashing determined by the ‘type’ of danger or hazard.

15. The apparatus and system of claim 13, wherein the intermittent flashing is an alternating high-intensity strobing light with red indicating smoke or fire, amber for carbon monoxide (CO), and blue for gas.

16. The apparatus and system of claim 10, wherein the pairing process of the series of remote sensing satellites is exclusive to an individual host.

17. The apparatus and system of claim 15, wherein the individual host is a distributed system of hosts where each host is exclusively paired to a series of remote sensing satellites to create a group of network devices that creates a whole-house blanket of coverage.

18. The apparatus and system of claim 15, wherein the monitoring, system testing, and system configurations of the base station includes a system-wide status notification which displays “ALL SYSTEMS OK” when all grouped danger or hazard detection devices are in a quiescent state and, upon an alarm activation from any one of the plurality of hosts and/or paired remote sensing satellites, displays the precise alert type and exact location of the alarm.

19. The apparatus and system of claim 17, wherein the status, of either ‘ALL SYSTEMS OK’ or defining an exact ‘type’ and identifying the exact location of the alarm, is further transmitted to a cellphone connected to the distributed network.

20. The apparatus and system of claim 14, wherein the alternating high-intensity strobing lights are interspersed three-second intervals of green and white color with the color green as the safety signal and the color white as illumination to guide the evacuation route, ensuring accurate hazard detection, location signaling, and efficient evacuation support.

21. The apparatus and system of claim 19, wherein alternating high-intensity strobing lights include one-half second intervals of colored strobing light, with the color corresponding to the type of danger detected, providing a clear indication of the nature of the threat.
